(19) United States
(12) Patent Application Publication
(10) Pub. No.: US 2024/0232709 A1
(43) Pub. Date: Jul. 11, 2024

(54) SYSTEM AND A METHOD OF GENERATING A TRAINING SET OF DATA FOR TRAINING A MACHINE-LEARNING ALGORITHM

(71) Applicant: Direct Cursus Technology L.L.C, Dubai (AE)

(72) Inventors: Daniil BURLAKOV, Moscow (RU); Vadim SHILOV, Perm (RU)

(21) Appl. No.: 18/394,988

(22) Filed: Dec. 22, 2023

(30) Foreign Application Priority Data
Dec. 22, 2022 (RU) 2022133953

(51) Int. Cl. G06N 20/00; G06Q 30/0601

(52) U.S. Cl. CPC G06N 20/00; G06Q 30/0631

(57) ABSTRACT

A method and a server for generating a training set of data for training a Machine-Learning Algorithm (MLA) to generate digital item recommendations for users of an online recommendation platform are provided. The method comprises generating synthetic user feedback for new digital items, devoid of any actual user feedback. The generating comprises: (i) during a first stage, training, by the server, a scoring machine-learning model to determine a predicted indication of the user feedback for a given digital item; and (ii) during a second stage: acquiring an indication of a given new digital item of a respective new item provider; applying the scoring machine-learning model to the given new digital item to determine a respective indication of the synthetic user feedback therefor; and generating, based on the new digital items with respective indications of the synthetic user feedback assigned thereto, the training set of data for training the MLA.

### CROSS-REFERENCE

The present application claims priority to Russian Patent Application No. 2022133953, entitled “System and a Method of Generating a Training Set of Data for Training a Machine-Learning Algorithm”, filed Dec. 22, 2022, the entirety of which is incorporated herein by reference.

### FIELD

The present technology relates generally to recommendation systems; and in particular, to a method of generating a training set of data for training a machine-learning algorithm to provide item recommendations to users of a given recommendation system.

### BACKGROUND

Online recommendation platforms host various digital items to be provided to the users thereof. Some of the online recommendation platforms comprise streaming services, for example, audio or video streaming services as a Sportify™ audio streaming service, a Yandex.Music™ audio streaming service, a Netflix™ video streaming service, an Amazon™ Prime Video video streaming service, and the like, hosting various audio tracks and video clips. Other online recommendation platforms can be implemented as online listing platforms, such as a Yandex™ Market online listing platform, an Amazon™ online listing platform, an Ozon.ru™ online listing platform, and others, allowing the users thereof to purchase various goods and services online. Thus, various item providers, such as singers, film producers, or online sellers, upload millions or even tens of millions of digital items to the given online recommendation platform for presentation to the users.

To assist the user in navigating through such a number of digital items hosted by the given online recommendation platform and increase their user satisfaction from interacting therewith, the given online recommendation platform can be configured to provide the user with user recommendations. For example, the user may be appreciating a given digital item on the given online recommendation platform, such as an audio track on an audio streaming service, and the given online recommendation platform can be configured to provide a recommended digital item to be appreciated after the given digital item. In another example, the given online recommendation platform can be configured to determine and further provide recommended digital items to the user in response to the user starting up the given online recommendation platform on her/his electronic device or submitting a general request for recommendations. The recommended digital items can be, for example, of a similar category or by the same item provider.

Generally speaking, to generate customized user recommendations for the users, such online recommendation platforms can execute machine-learning algorithm (MLA) specifically trained for this purpose. More specifically, the MLA can be trained based on a training set of data including various features indicative of one or more of (i) the users of the given online recommendation platform; (ii) the digital items hosted thereat; and (iii) past user interactions of the users with the digital items. The latter can include user feedback that the users leave under the digital items after appreciation thereof, such as “LIKES/DISLIKES”, comments, and others.

However, new digital items uploaded to the given online recommendation platform, due to being devoid of any prior user feedback from the users, may lack certain features and hence be disregarded by the MLA when generating the user recommendations. This problem is also known in the art as a problem of a “cold start” when the new digital items are not part of recommended digital items for the users of the given online recommendation platform due to not having yet been interacted with or reviewed by other users. Consequently, the users may miss relevant user recommendations including the new digital items; and the new item providers may not be able to attract their target audience on the given online recommendation platform. The user experience of both parties can thus be compromised.

Certain prior art approaches have been proposed to tackle the above-identified technical problem.

U.S. Patent Application Publication No.: 2006/085,818-A1 published on Apr. 20, 2006, assigned to Koninklijke Philips NV, and entitled “INTRODUCING NEW CONTENT ITEMS IN A COMMUNITY-BASED RECOMMENDATION SYSTEM” discloses a method of operating with content items, generating of a user preference profile, and introducing new content items in a community-based recommendation system. A virtual user terminal determines a new user preference profile when detecting the availability of a new content item. The virtual user terminal comprises an initialization processor which sets a preference value in the user preference profile for the new content item. The virtual user terminal further comprises a relation processor which determines related content items, and a profile processor, which sets preference values in the user preference profile associated with the at least one related content item. Hence, an association is formed between the first content item and the related content items, thereby linking the new content item to existing content items, and thus increasing the probability that the new content item is recommended.

Chinese Patent Application Publication No.: 114,238,752-A published on Mar. 25, 2022, assigned to Hunan University, and entitled “ARTICLE RECOMMENDATION METHOD AND DEVICE AND STORAGE MEDIUM”, discloses an article recommendation method and related equipment, which can improve the accuracy of cold start. The method comprises the following steps: determining multi-modal information of each cold-starting object in the cold-starting object set and multi-modal information of each warm object in the warm object set, wherein the multi-modal information comprises at least two of identification information, visual information characteristics, audio information characteristics and text information characteristics; performing hierarchical clustering according to the multi-modal information of each cold start object and the multi-modal information of each warm object to obtain a plurality of clustering results; constructing a supplementary interaction graph between each cold start object and a warm object according to the plurality of clustering results, wherein the warm object corresponds to the warm object set; determining a first final representation of each cold-starting object and a second final representation of a warm object corresponding to each cold-starting object according to the complementary interaction graph; and recommending each cold start object according to the first final representation and the second final representation.

Chinese Patent No.: 108,334,592-B issued on Nov. 2, 2021, assigned to Nanjing University of Posts and Telecommunications, and entitled “PERSONALIZED RECOMMENDATION METHOD BASED ON COMBINATION OF CONTENT AND COLLABORATIVE FILTERING”, discloses a personalized recommendation method based on combination of content and collaborative filtering, which comprises two stages of training and personalized recommendation: in the training stage, an existing user-new article pre-recommendation matrix is formed by collecting data information, and in the personalized recommendation stage, article recommendation of a new user and further recommendation after the user generates scores are completed. Compared with the traditional personalized recommendation method, the method and the system can solve the cold start problem, predict the newly added articles, recommend the newly added articles to the user, and use collaborative filtering recommendation after pre-recommendation, so that the diversity and accuracy of recommended articles are improved. And moreover, the matrix dimension is greatly reduced by generating the virtual users through the clustering algorithm, and meanwhile, the calculation complexity is reduced.

### SUMMARY

Therefore, there is a need for systems and methods which avoid, reduce or overcome the limitations of the prior art.

Developers of the present technology have devised methods and system to address the problem of a “cold start” for the new digital items having been uploaded to the given online recommendation platform. More specifically, the developers have devised methods and systems for generating synthetic user feedback for the new digital items based on the actual user feedback provided to the existing, old, digital items of the given online recommendation platform by the users thereof.

In some non-limiting embodiments of the present technology, the present methods and systems are directed to training a scoring machine-learning (ML) model to determine the synthetic user feedback can be assigned to the new digital items. More specifically, in these embodiments, the scoring ML model is trained to reproduce a current feedback distribution of indication of the actual user feedback provided to the old digital items, such as “likes”, “dislikes”, as an example.

According to at least other non-limiting embodiments of the present technology, the synthetic user feedback for the new digital items uploaded to the given online recommendation platform by a given new item provider can mimic the actual user feedback given to the old digital items of a respective old item provider that is similar to the given new item provider. To that end, in these embodiments, the present methods and systems are directed to (i) determining the current feedback distribution of the indications of the actual user feedback provided over the old digital items of the respective old item provider; and (ii) assigning indications of the synthetic user feedback to the new digital items in accordance with the so determined current feedback distribution.

Having such synthetic user feedback, the new digital items would be considered by the MLA of the given online recommendation platform and may thus constitute user recommendations for the users. By doing so, the methods described herein may allow for better introduction of the new digital items to the users of the given online recommendation platform, enabling the new digital items to receive the actual user feedback, which (if different) can further replace the synthetic user feedback.

Thus, various non-limiting embodiments of the present technology may allow for improving user experience of the users and items providers of online recommendation platforms.

More specifically, in accordance with a first broad aspect of the present technology, there is provided a method of generating a training set of data for training a Machine-Learning Algorithm (MLA) to generate digital item recommendations for users of an online recommendation platform. The online recommendation platform hosts a plurality of digital items. The plurality of digital items includes: (i) an old portion of digital items, each one of the old portion of digital items having been uploaded to the online recommendation platform by a respective one of a plurality of old item providers; and at least some old digital items of the old portion of digital items having received user feedback from at least one user of the online recommendation platform, indications of the user feedback of the at least some old digital items being distributed over the old portion of digital items according to a feedback distribution; and (ii) a new portion of digital items, each one of the new portion of digital items having been uploaded to the online recommendation platform by a respective new item provider of a plurality of new item providers; and cach digital item of the new portion of digital items being devoid of any user feedback. The generating the training set of data comprises generating synthetic user feedback for new digital items. The method is executable by a server hosting the online recommendation platform. The method comprises: during a first stage, training, by the server, a scoring machine-learning model to determine a predicted indication of the user feedback for a given digital item, the training comprising: acquiring, by the server, indications of the old portion of digital items to generate a plurality of scoring training digital objects, a given one of which includes: (i) a given old digital item of the old portion of digital items; and (ii) a respective indication of the user feedback received by the given old digital item; and feeding, by the server, the plurality of scoring digital objects to the scoring machine-learning model, thereby training the scoring machine-learning model to determine the predicted indication of the user feedback for the given digital item using the feedback distribution of the indications of the user feedback over the old portion of digital items as a ground truth; and during a second stage, following the first stage, executing: acquiring, by the server, an indication of a given new item provider of the plurality of new item providers; the given new item provider having uploaded, to the online recommendation platform, a respective plurality of new digital items of the new portion of digital items; applying, by the server, the scoring machine-learning model to a given new digital item of the respective plurality of new digital items of the given new item provider to determine a respective indication of the synthetic user feedback for the given new digital item; generating, by the server, the training set of data including a plurality of training digital objects, a given training digital object including (i) the given one of the respective plurality of new digital items of the given new item provider; and (ii) the respective indication of the synthetic user feedback; and feeding, by the server, the plurality of training digital objects to the MLA to train the MLA to generate the digital item recommendations.

In some implementations of the method, the applying the scoring machine-learning model comprises determining a first probability value of the given new digital item of the given new digital item provider receiving an indication of positive user feedback, the determining being based on a respective similarity score of the given new item provider relative to the plurality of old item providers.

In some implementations of the method, the determining the first probability value is executed in accordance with a formula:

$$artistProb = a \cdot artistScore + b ,$$

where artistScore is the respective similarity score of the given new item provider relative to the plurality of old item providers; and
a and b are coefficients determined via the training the scoring machine-learning model.

In some implementations of the method, the method further comprises determining, by the server, the respective similarity score of the given new item provider relative to the plurality of old item providers.

In some implementations of the method, the determining the respective similarity score of the given new item provider comprises: acquiring, for a given old item provider of the plurality of old item providers, a respective value of a similarity parameter between the given old item provider and the given new item provider; based on respective values of the similarity parameter between each one of the plurality of old item providers and the given new item provider, generating, by the server, a directed graph structure, such that: a given vertex of the directed graph structure is representative of a respective item provider of one of the plurality of old item providers and the plurality of new item providers; a given edge connecting a pair of vertices is representative of a non-zero respective value of the similarity parameter between the given new item provider and a respective one of the plurality of old item providers; determining, by the server, for the given edge, a respective weight value indicative of the respective value of the similarity parameter between the given new item provider and the respective one of the plurality of old item providers; and determining, by the server, the respective similarity score of the given new item provider as being a maximum total weight value along a transition from a respective vertex of the directed graph structure associated with the given new item provider to an initial vertex thereof.

In some implementations of the method, the determining the respective weight value comprises determining an inverse value of the respective value of the similarity parameter between the given new item provider and the respective one of the plurality of old item providers.

In some implementations of the method, the similarity parameter is a rank of similarity between the given new item provider and each one of the plurality of old item providers.

In some implementations of the method, the method further comprises receiving the rank of similarity between the given new item provider and each one of the plurality of old item providers from a human assessor.

In some implementations of the method, the applying the scoring machine-learning model further comprises determining a second probability value of the given new digital item of the given new digital item provider receiving the indication of positive user feedback, the determining being based on a respective popularity value of the given new digital item in a given area.

In some implementations of the method, the determining the second probability value is executed in accordance with a formula:

$$trackProb = c \cdot \frac{Populairty - minPopularity}{maxPopularity - minPopularity} + d ,$$

where Popularity is the respective popularity value of the given new digital item in the given area;
   maxPopularity is the respective popularity value of a most popular new digital item of the respective plurality of digital items of the given new item provider in the given area;
   minPopularity is the respective popularity value of a least popular new digital item of the respective plurality of digital items of the given new item provider in the given area; and
   c and d are coefficients determined via the training the scoring machine-learning model.

In some implementations of the method, the given new digital item is an audio feed; and the respective popularity value of the given new digital item is indicative of at least one of: (i) a number of streams of the audio feed on a given media resource; (ii) a number of requests to play the audio feed on the given media resource; (iii) a position of the audio feed in a given record chart; and (iv) a number of sold albums including the audio feed.

In some implementations of the method, the method further comprises: in response to at least one of the first and second probability values being greater than a respective upper probability threshold, assigning, by the server, to the given new digital item, an indication of the positive synthetic user feedback; and in response to the at least one of the first and second probability values being lower than a respective lower probability threshold, the respective lower probability threshold being lower than the respective upper probability threshold, assigning, by the server, to the given new digital item, an indication of negative synthetic user feedback.

In some implementations of the method, prior to the applying the scoring machine-learning model, the method further comprises selecting, by the server, the given new digital item of the respective plurality of new digital items.

In some implementations of the method, the selecting comprises selecting the given new digital item from the respective plurality of new digital items one of (i) randomly; (ii) with a uniform sampling probability; (iii) with a respective sampling probability value proportional to the respective popularity value of the given new digital item in the given area; and (iv) with the respective sampling probability value proportional to the respective popularity value of the given new digital item in the given area.

In some implementations of the method, prior to the generating the training set of data, the selecting and the applying are executed iteratively for a predetermined number of iterations.

In some implementations of the method, in response to determining, by the server, that the given new digital item of the respective plurality of new digital items has received the user feedback, the method further comprises: updating, by the server, the given training digital object of the plurality of training digital objects by replacing therein the respective indication of the synthetic user feedback with a respective indication of the user feedback.

In some implementations of the method, the scoring machine-learning model is a matrix factorization machine-learning model.

In some implementations of the method, the MLA is one of a decision tree-based MLA, Transformer-based MLA, and a Deep Semantic Similarity MLA.

Further, in accordance with a second bras aspect of the present technology, there is provided a method of generating a training set of data for training a Machine-Learning Algorithm (MLA) to generate digital item recommendations for users of an online recommendation platform. The online recommendation platform hosts a plurality of digital items. The generating the training set of data comprising generating synthetic user feedback for new digital items. The method is executable by a server hosting the online recommendation platform. The method comprises: acquiring, by the server, an indication of a given new item provider of the new item providers, the given new item provider having a plurality of new digital items to be uploaded to the online recommendation platform, a given new digital item of the plurality of new digital items being devoid of previous user feedback; acquiring, by the server, an indication of a plurality of old item providers having uploaded a respective plurality of old digital items, at least some of the respective plurality of old digital items having received user feedback from at least one user of the online recommendation platform; analyzing, by the server, the given new item provider and the plurality of old item providers for determining a respective reference old item provider, the determining being executed based on a similarity parameter between the given new item provider and each of the plurality of old item providers; based on the user feedback received by the respective plurality of old digital items of the respective reference old item provider, determining, by the server, the synthetic user feedback for the plurality of new digital items of the given new item provider, the determining including: determining, by the server, a feedback distribution of indications of the user feedback over the respective plurality of reference digital items associated with the respective reference old item provider; and assigning, by the server, indications of the synthetic user feedback over the plurality of new digital items of the given new item provider in accordance with the feedback distribution of the indications of the user feedback over the respective plurality of reference digital items of the respective reference old item provider; generating, by the server, the training set of data including a plurality of training digital objects, a given training digital object including (i) the given one of the plurality of new digital items of the given new item provider; and (ii) a respective indication of the synthetic user feedback; and feeding, by the server, the plurality of training digital objects to the MLA to train the MLA to generate the digital item recommendations.

Further, in accordance with a third broad aspect of the present technology, there is provided a server for generating a training set of data for training a Machine-Learning Algorithm (MLA) to generate digital item recommendations for users of an online recommendation platform hosted by the server. The online recommendation platform hosts a plurality of digital items. The plurality of digital items includes: (i) an old portion of digital items, cach one of the old portion of digital items having been uploaded to the online recommendation platform by a respective one of a plurality of old item providers; and at least some old digital items of the old portion of digital items having received user feedback from at least one user of the online recommendation platform, indications of the user feedback of the at least some old digital items being distributed over the old portion of digital items according to a feedback distribution; and (ii) a new portion of digital items, cach one of the new portion of digital items having been uploaded to the online recommendation platform by a respective new item provider of a plurality of new item providers; and each digital item of the new portion of digital items being devoid of any user feedback. The generating comprises generating synthetic user feedback for new digital items. The server comprising a processor and a non-transitory computer-readable memory storing instructions. The processor, upon executing the instructions, is configured to: during a first stage, train a scoring machine-learning model to determine a predicted indication of the user feedback for a given digital item, by executing: acquiring indications of the old portion of digital items to generate a plurality of scoring training digital objects, a given one of which includes: (i) a given old digital item of the old portion of digital items; and (ii) a respective indication of the user feedback received by the given old digital item; and feeding the plurality of scoring digital objects to the scoring machine-learning model, thereby training the scoring machine-learning model to determine the predicted indication of the user feedback for the given digital item using the feedback distribution of the indications of the user feedback over the old portion of digital items as a ground truth; and during a second stage, following the first stage, execute: acquiring an indication of a given new item provider of the plurality of new item providers; the given new item provider having uploaded, to the online recommendation platform, a respective plurality of new digital items of the new portion of digital items; apply the scoring machine-learning model to a given new digital item of the respective plurality of new digital items of the given new item provider to determine a respective indication of the synthetic user feedback for the given new digital item; generate the training set of data including a plurality of training digital objects, a given training digital object including (i) the given one of the respective plurality of new digital items of the given new item provider; and (ii) the respective indication of the synthetic user feedback; and feed the plurality of training digital objects to the MLA to train the MLA to generate the digital item recommendations.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims, and accompanying drawings where:

FIG. 1 depicts a schematic diagram of an example computer system configurable for implementing certain non-limiting embodiments of the present technology;

FIG. 2 depicts a schematic diagram of a networked computing environment including the computer system of FIG. 1 and being suitable for use with certain non-limiting embodiments of the present technology;

FIG. 3 depicts a schematic diagram of a Graphical User Interface of an online recommendation platform hosted by a server present in the networked computing environment of FIG. 2, in accordance with certain non-limiting embodiments of the present technology;

FIGS. 4A and 4B depict schematic diagrams of input and output data of a scoring machine-learning (ML) model used, by the server of the networked computing environment of FIG. 2, to determine predicted indications of user feedback for the plurality of digital items of the online recommendation platform, in accordance with certain non-limiting embodiments of the present technology;

FIG. 5 depicts a schematic diagram of an item provider similarity graph of item providers of the plurality of digital items hosted by the online recommendation platform, in accordance with certain non-limiting embodiments of the present technology;

FIG. 6 depicts a schematic diagram of a step for determining similarity between new and old item providers of the plurality of digital items hosted by the online recommendation platform, in accordance with certain non-limiting embodiments of the present technology;

FIG. 7 depicts a schematic diagram of a machine-learning model architecture used for implementation at least some non-limiting embodiments of the present technology;

FIG. 8 depicts a flowchart diagram of a first method of generating, by the server of the networked computing environment of FIG. 2, a training set of data for training a machine-learning algorithm (MLA) to generate digital item recommendations for the users of the online recommendation platform, in accordance with certain non-limiting embodiments of the present technology; and

FIG. 9 depicts a flowchart diagram of a second method of generating, by the server of the networked computing environment of FIG. 2, the training set of data for training the MLA to generate digital item recommendations for the users of the online recommendation platform, in accordance with certain non-limiting embodiments of the present technology.

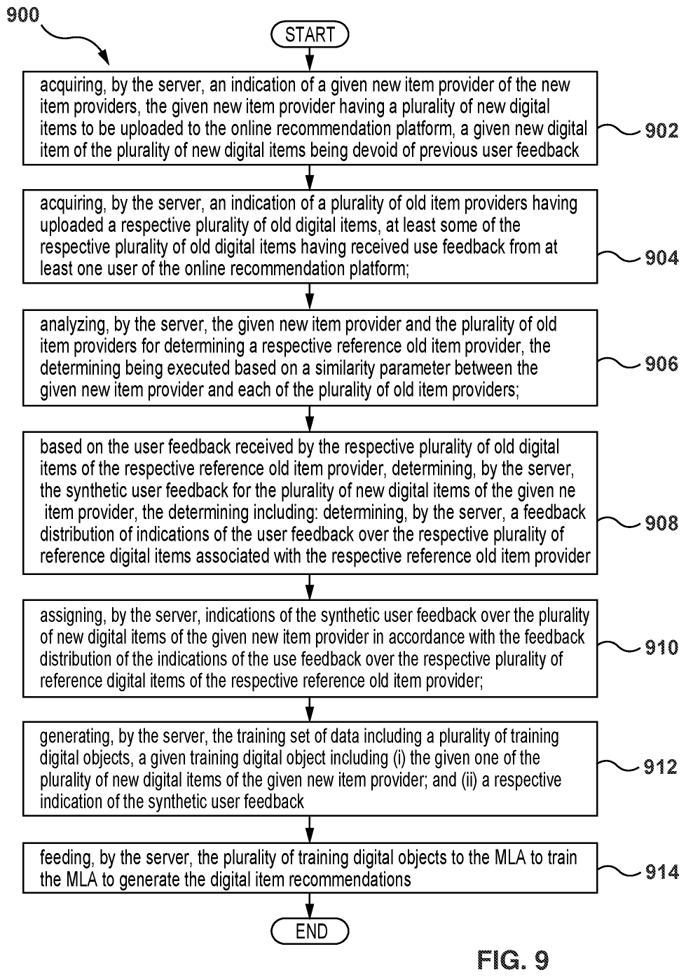

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

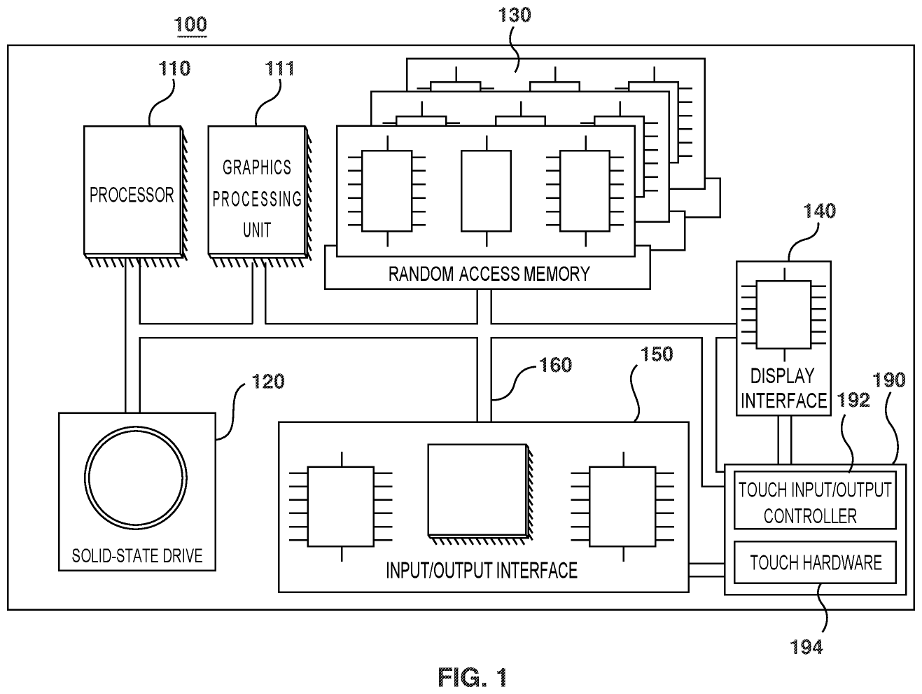

With reference to FIG. 1, there is depicted a computer system 100 suitable for use with some implementations of the present technology. The computer system 100 comprises various hardware components including one or more single- or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

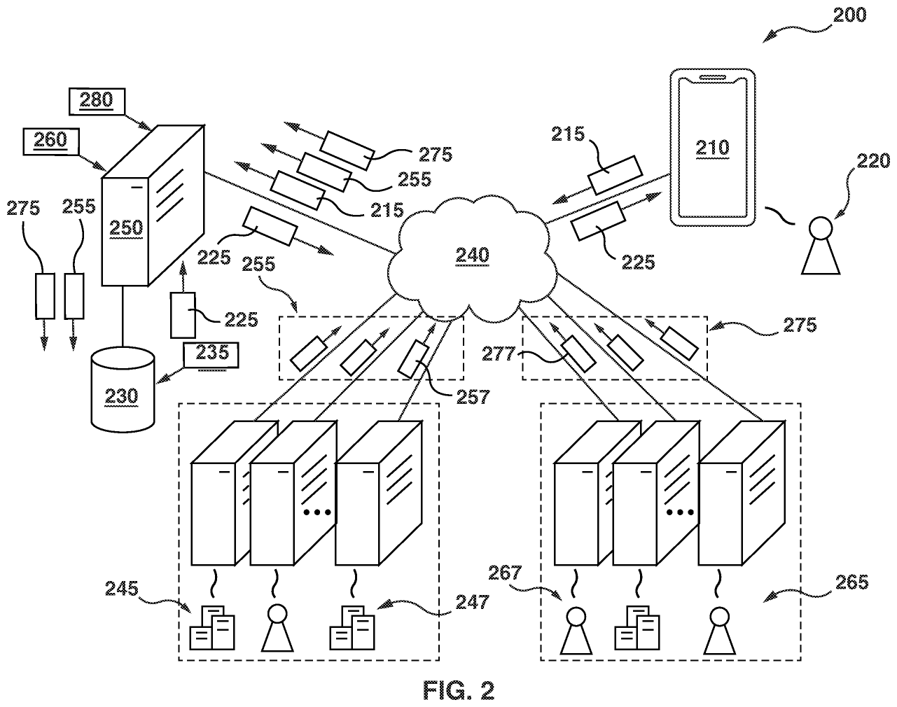

The input/output interface 150 may be coupled to a touchscreen 190 and/or to the one or more internal and/or external buses 160. The touchscreen 190 may equally be referred to as a screen—such as a screen (not separately labelled) of an electronic device 210 depicted in FIG. 2. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the touchscreen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

With reference to FIG. 2, there is depicted a schematic diagram of a networked computing environment 200 suitable for use with some non-limiting embodiments of the present technology. The networked computing environment 200 includes an electronic device 210 communicatively coupled, via a communication network 240, with a server 250. In some non-limiting embodiments of the present technology, the electronic device 210 may be associated with a user 220.

In the non-limiting embodiments of the present technology, the electronic device 210 may be any computer hardware that is capable of running a software appropriate to the relevant task at hand. Thus, some non-limiting examples of the electronic device 210 may include personal computers (desktops, laptops, netbooks, etc.), smartphones, and tablets. Thus, the electronic device 210 may comprise some or all components of the computer system 100 depicted in FIG. 1.

According to certain non-limiting embodiments of the present technology, the server 250 can be configured to host an online recommendation platform 260; and the processor 110 of the electronic device 210 can be configured to access the online recommendation platform 260 via the communication network 240. Broadly speaking, the online recommendation platform 260 is a web resource providing the user 220 with access to a plurality of digital items 235 stored in a database 230 communicatively coupled to the server 250 via a respective communication link. The online recommendation platform 260 can be configured to identify digital items that may interest the user 220 and further transmit the indications of such digital items to the electronic device 210 for user's appreciation.

It is not limited how the online recommendation platform 260 can be implemented. In some non-limiting embodiments of the present technology, the online recommendation platform 260 can be implemented as an audio streaming platform, such as a Sportify™ audio streaming platform, a Yandex. Music™ audio streaming platform, a YouTube.Music™ audio streaming platform, and others; and the plurality of digital items 235 stored in the database 230 can comprise various audio tracks, such as songs, podcasts, audio books, and the like. In other non-limiting embodiments of the present technology, the online recommendation platform can be implemented as video streaming platform, such as a Netflix™ video streaming platform, an Amazon™ Prime Video streaming platform, and others; and the plurality of digital items 235 can comprise video clips, films, and TV programs, as an example. In yet other non-limiting embodiments of the present technology, the online recommendation platform 260 can be implemented as an online listing platform, such as a Yandex. Market™ online listing platform, and Amazon™ online listing platform; and the plurality of digital items 235 can comprise classified listings of various goods and services available for online purchasing. Other implementations of the online recommendation platform 260 are also envisioned without departing from the scope of the present technology.

In some non-limiting embodiments of the present technology, the server 250 can be implemented as a conventional computer server and may comprise some or all of the components of the computer system 100 of FIG. 1. In one non-limiting example, the server 250 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 250 is a single server. In alternative non-limiting embodiments of the present technology (not depicted), the functionality of the server 250 may be distributed and may be implemented via multiple servers.

In some non-limiting embodiments of the present technology, the server 250 can be operated by the same entity that runs the online recommendation platform 260. For example, if the online recommendation platform 260 is the Yandex. Music™ audio streaming platform, the server 250 can also be operated by Yandex LLC of 16 Lev Tolstoy Street, Moscow, 119021, Russia. In alternative non-limiting embodiments of the present technology, the server 250 can be operated by an entity different from the one that has provided the online recommendation platform 260.

For example, using the electronic device 210, the user 220 can be enabled to access the online recommendation platform 260 from the electronic device 210. Further, the user 220 can be enabled to submit a recommendation request 215 to server 250. In response, the server 250 can be configured to (i) identify a set of recommended digital items 225 and (ii) transmit indications of the set of recommended digital items 225 to the electronic device for presentation to the user 220. It is not limited how the recommendation request 215 can be submitted by the user 220.

### Communication Network

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network are for illustration purposes only. How a respective communication link (not separately numbered) between each one of the electronic device 210, the server 250, and the communication network 240 is implemented will depend, inter alia, on how each one of the electronic device 210 and the server 250 is implemented. Merely as an example and not as a limitation, in those embodiments of the present technology where the electronic device 210 is implemented as a wireless communication device such as the smartphone, the communication link can be implemented as a wireless communication link. Examples of wireless communication links include, but are not limited to, a 3G communication network link, a 4G communication network link, and the like. The communication network 240 may also use a wireless connection with the server 250.

### Recommendation Platform

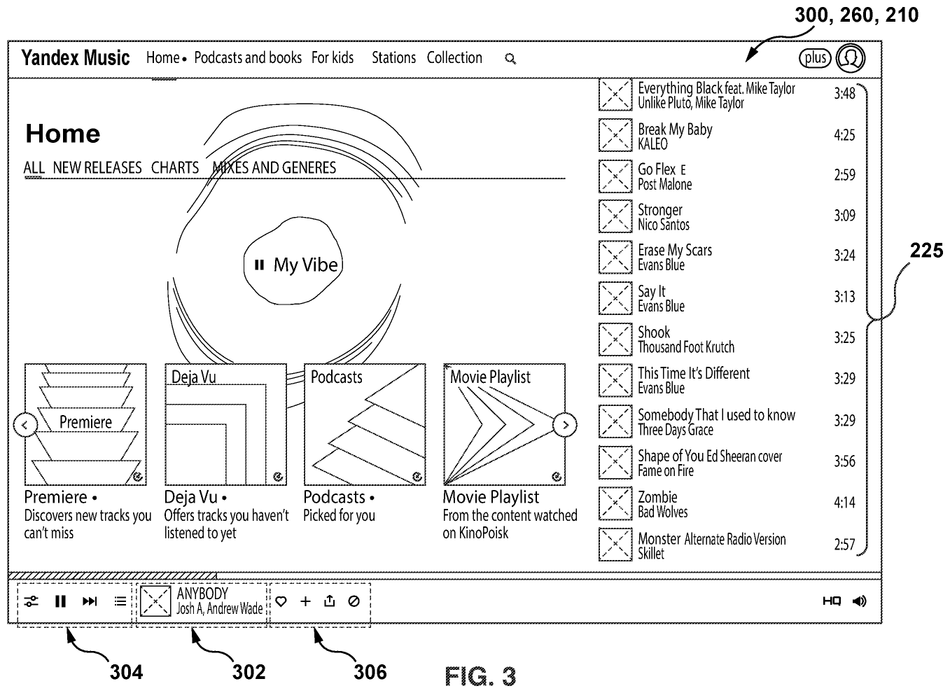

With reference to FIG. 3, there is depicted a graphical user interface (GUI) 300 of the online recommendation platform 260 rendered in the electronic device 210 associated with the user 220, in accordance with certain non-limiting embodiments of the present technology.

According to certain non-limiting embodiments of the present technology, the server 250 can be configured to cause the electronic device 210 to render the GUI 300 in response to the user 220 submitting a request for accessing the online recommendation platform 260, such as by submitting a Universal Resource Locator (URL) of the server 250 to a browser application (not separately depicted) of the electronic device 210 or launching thereon an application (not separately numbered in FIG. 3) associated with the online recommendation platform 260.

As it can be appreciated, in some non-limiting embodiments of the present technology, the GUI 300 can include at least: (i) respective indications of at least a portion of the set of recommended digital items 225, defined, for example, by dimensions of a screen of the electronic device 210; (ii) an indication of a currently presented recommended digital item 302; control actuators 304 enabling the user 220 to control the presentation of a given recommended digital item; and (iii) feedback actuators 306 enabling the user 220 to leave their feedback on the given recommended digital item of the set of recommended digital items 225, such as the currently presented recommended digital item 302.

Although in the embodiments depicted in FIG. 3, the GUI 300 is representative of the online recommendation platform 260 implemented as an audio streaming platform, it should be expressly understood that, in other non-limiting embodiments of the present technology, similar GUIs can be rendered for other types of the online recommendation platform 260, non-exhaustively listed above.

Further, it is not limited how the recommendation request 215 for the set of recommended digital items 225 can be submitted from electronic device 210. In some non-limiting embodiments of the present technology, the user 220 can be enabled, such as via a dedicated actuator (such as “Play Radio”, in the example where the online recommendation platform 260 is an audio streaming platform, not depicted in FIG. 3) of the GUI 300, to expressly submit the recommendation request 215 to the server 250. In other non-limiting embodiments of the present technology, the recommendation request 215 can be triggered by the user 220 accessing the online recommendation platform 260 from the electronic device 210, launching the GUI 300. In yet other non-limiting embodiments of the present technology, the recommendation request 215 can be triggered by the user 220 appreciating the given digital item of the plurality of digital items 235.

In some non-limiting embodiments of the present technology, as will described in detail below, the server 250 can be configured to generate the set of recommended digital items 225 for the user 220 based at least on a respective item popularity value of each digital item in the plurality of digital items 235. According to certain non-limiting embodiments of the present technology, the server 250 can be configured to determine the respective item popularity value for a given digital item of the plurality of digital items 235 hosted by the online recommendation platform 260 based on user interactions of the users of the online recommendation platform 260, such as those of the user 220, with the given digital item. In some non-limiting embodiments of the present technology, such user interactions can include, for example, providing, such as by using the feedback actuators 306, the user feedback under the given digital item.

According to certain non-limiting embodiments of the present technology, the GUI 300 of the online recommendation platform 260 can include the feedback actuators 306 enabling the user feedback to be indicated by a binary value, such as “LIKE” or “DISLIKE”, respectively indicative of the positive or negative user engagement of the user 220 with the given digital item. In other non-limiting embodiments of the present technology, the feedback actuators 306 can include a different configuration (such as star indicators, emotion indicators, and the like, not depicted) enabling indication of the user feedback by one of values of a predetermined value range, such as from “1” to “5” or from “1” to “10”, for example, where “1” is indicative of the negative user engagement of the user 220 with the given digital item, and “5” or “10”, respectively, are indicative the positive user engagement of the user 220 with the given digital item.

In some non-limiting embodiments of the present technology, the server 250 can be configured to determine the respective item popularity value for the given digital item based on other user interactions of the user 220 with the given digital item, which, akin to the user feedback, can also be indicative of positive or negative user engagement with the given digital item. According to certain non-limiting embodiments of the present technology, such other user interactions of the user 220 indicative of the positive user engagement with the given digital item can include: (i) selecting the given digital item for appreciation; (ii) searching for the given digital item on the online recommendation platform 260; (iii) sharing the given digital item via accounts of the user 220 on social networks; (iv) putting presentation of the given digital item on repeat; (v) adding the given digital item to a list of favorite digital items of the user 220; and the like.

By contrast, the user interactions of the user 220 indicative of the negative user engagement with the given digital item of the plurality of digital items 235 can include, for example, without limitation: (i) skipping forward the given digital item; (ii) skipping the given digital item in its entirety to a sequentially following digital item; (iii) aborting the presentation of the given digital item followed by searching an other digital item for appreciation; and the like. Other user interactions of the user 220, indicative of both the positive and negative user engagement with the given digital item, are also envisioned without departing from the scope of the present technology.

Thus, according to certain non-limiting embodiments of the present technology, in response to receiving the recommendation request 215 from the electronic device 210, based at least on the indications of the user feedback, the server 250 can be configured to (i) determine the respective item popularity value of each one of the plurality of digital items 235; and (ii) identify, based on the respective item popularity values, in the plurality of digital items 235, the set of recommended digital items 225 for providing to the user 220, as described above. For example, a given recommended digital item of the set of recommended digital items 225 can be one of top popular digital items of the plurality of digital items 235. In another example, the server 250 can be configured to identify the given recommended digital item as being a digital item provided by a same item provider that is associated with at least one of the top popular digital items. In yet other example, the server 250 can be configured to identify the given recommended digital item for the user 220 as being a digital item that is top popular among users that are similar, based on predetermined user features, to the user 220.

In some non-limiting embodiments of the present technology, the server 250 can be configured to identify the set of recommended digital items 225 such that a likelihood value of the positive user engagement of the user 220 with each one of the set of recommended digital items 225, indicated, for example, by positive user feedback, is maximized. In other non-limiting embodiments of the present technology, the server 250 can be configured to identify the set of recommended digital items 225 such that a likelihood value of the negative user engagement of the user 220 with each one of the set of recommended digital items 225, indicated, for example, by negative user feedback, is minimized.

To that end, for example, in some non-limiting embodiments of the present technology, the server 250 can be configured to identify recommended digital items for the set of recommended digital items 225 that have similar item features with those digital items, with which the user 220 has had most positive user engagement, as mentioned above. In another example, the server 250 can be configured to identify the recommended digital items for inclusion thereof in the set of recommended digital items 225 among those having received positive user engagements of other users of the online recommendation platform 260 that have similar user features with the user 220.

According to certain non-limiting embodiments of the present technology, the item features associated with the given digital item may be indicative of inherent parameters thereof; and, as it can be appreciated, can depend on a nature of the given digital item. For example, in those embodiments where the online recommendation platform 260 is an audio streaming platform, and the given digital item is a respective audio track, the item features can include, without limitation, (i) a genre of the respective audio track; (ii) a predetermined mood to be induced by the respective audio track; (iii) a period of popularity associated with the respective audio track, such as the sixties, the seventies, the nineties, and the like; (iv) a respective item provider of the respective audio track, such as an artist, a producer, a production studio, and the like; (v) a duration of the respective audio track; (vi) a release date of the respective audio track; (vii) a rhythm of the respective audio track; (viii) an album of the respective audio track; and the like.

Further, the user features of a given user of the online recommendation platform 260, such as the user 220, can include, without limitation: (i) sociodemographic characteristics of the user 220, which may further include, without limitation, an age of the user 220, a gender of the user 220, an employment status of the user 220, an average income of the user 220, and the like; (ii) data indicative of a search history of the user 220; (iii) data indicative of a web browsing history of the user 220; and the like.

In some non-limiting embodiments of the present technology, to identify the set of recommended digital items 225 for the user 220 as mentioned above, the server 250 can be configured to execute a machine-learning algorithm (MLA) 280 trained to identify recommended digital items based on the above features for each user of the online recommendation platform 260. More specifically, executing the MLA 280 can be trained to determine respective likelihood values of the user 220 positively engaging with each one of the plurality of digital items 235, such as the user 220 leaving positive user feedback thereon. Further, the server 250 can be configured to (i) rank the digital items according to respective likelihood values; and (ii) select N top digital items, such as 100, 500, or 1000, for example, as for inclusion in the set of recommended digital items 225.

As will be described in greater detail below, according to certain non-limiting embodiments of the present technology, the server 250 can be configured to train the MLA 280 based on a training set of data including a plurality of training digital objects, a given training digital objects of which may include, without limitation: (i) an indication of a respective digital item of the plurality of digital items 235; (ii) item features of the respective digital item; (iii) indications of past user interactions of the users of the online recommendation platform 260, such the user feedback provided to the respective current digital item, as described above, with the respective digital item; and (iv) user features of the users having interacted with the respective digital item, such as left their user feedbacks thereunder.

Thus, by identifying and providing recommended digital items to the users of the online recommendation platform 260, the server 250 can be configured to: (i) introduce various digital items to the users; (ii) elicit their user feedback on the recommended digital items; and (iii) based on the user feedback, improve accuracy of further recommendations. As it can be appreciated, providing the recommended items thus allows improving user experience of both (i) the users, due to providing thereto digital items of interest; and (ii) item providers, due to introducing various digital items thereof among the users of the online recommendation platform 260, allowing the items providers to represent thereon their digital items more comprehensively.

According to certain non-limiting embodiments of the present technology, the plurality of digital items 235 hosted by the online recommendation platform 260, can include (i) an old portion of digital items 255 uploaded to the online recommendation platform 260 by a plurality of old item providers 245 via respective electronic devices (not separately labelled) thereof; and (ii) a new portion of digital items 275 uploaded to the online recommendation platform 260 by a plurality of new item providers 265 via respective electronic devices (not separately labelled) thereof.

In the context of the present specification, the term “item provider” denotes broadly an entity, such as an individual, a musician or a music producer, for example, or an organization, such as a music production studio, for example, that have had a plurality of digital items uploaded to the online recommendation platform 260 for shared access among the users thereof.

Further, according to certain non-limiting embodiments of the present technology, a given old digital item of the old portion of digital items 255 denotes a digital item that has been available at the online recommendation platform 260 for longer than a predetermined availability period threshold, such as 1 week, 1 month, or 1 year, as an example. In other non-limiting embodiments of the present technology, the given old digital items can be defined as a digital item that has received at least one indication of the user feed back of at least one user of the online recommendation platform 260. In yet other non-limiting embodiments of the present technology, the given old digital item can be defined as a digital item provided by a respective one of the plurality of old item providers 245 that has been present at the online recommendation platform 260 for longer than a predetermined presence time threshold, which can be, for example a month, a quarter, or a year. Thus, in at least some non-limiting embodiments of the present technology, at least some of a plurality of old digital items 257 having been uploaded to the online recommendation platform 260 by a given old item provider 247 have received at least one respective indication of the user feedback from at least one user.

By contrast, in the context of the present specification, according to certain non-limiting embodiments of the present technology, a given new digital item of the new portion of digital items 275 is a digital item that is devoid of indications of any user interactions therewith, including the user feedback due to, for example, (i) having been available at the online recommendation platform 260 for shorter than the predetermined availability period threshold; or (ii) having been uploaded by a respective one of the plurality of new item providers 265 that is not known (popular) among the users of the online recommendation platform 260. For example, a plurality of new digital items 277 of a given new item provider 267 can become available at the online recommendation platform 260 as a result of the online recommendation platform 260 having expanded its service coverage to a new geographical territory, whose item providers have never been present at the online recommendation platform 260.

As each one of the plurality of new item digital items 277 is devoid of any user feedback or only has very limited user feedback, the server 250 can subsequently be incapable of determining the respective item popularity values of each one of the plurality of new item providers 277; and the MLA 280, trained to identify recommended digital items based, inter alia, on the respective item popularity values of the plurality of digital items 235, may disregard the plurality of new item digital items 277 of the given new item provider 267. Thus, none of the plurality of new item digital items 277 can be included in the set of recommended digital items 225.

Accordingly, such pessimization of the plurality of digital items 277 from inclusion thereof in the set of recommended digital items 225 may result in the user 220 missing relevant recommended digital items; and hence the given new item provider 267 missing their target audience.

One of naive approaches to tackle this problem of data sparsity would be inferring the respective item popularity values of each old digital item of the new portion of digital items 275 based on correlation between item features thereof and item features of each old digital item of the old portion of digital items 255. However, due to a potentially large number of various item features and digital items, such an analysis can be a very resource-intensive task for the processor 110 of the server 250.

Thus, developers of the present technology have appreciated that an indication of the user feedback can be determined directly for each new digital item of the new portion of digital items 275 based on indications of the user feedback distributed over the old portion of digital items 255. More specifically, the present methods and systems are directed to assigning to the digital items of the new portion of digital items 275 indications of synthetic user feedback, which is, as opposed to the actual user feedback, has not been provided by the users of the online recommendation platform 260 but determined by the server 250. In some non-limiting embodiments of the present technology, the present methods include training an algorithm to determine probability values of the users of the online recommendation platform 260 providing respective indications (both positive and negative) of the user feedback to the digital items of the new portion of digital items 275 based on a distribution of the respective indications of the user feedback over the old portion of digital items 255.

Thus, the new digital items of the new portion of digital items 275, having received the respective indications of the synthetic user feedback, can be considered by the MLA 280 during the process of determining the recommended digital items for the user 220, which enables for introduction of the new digital items to the users of the online recommendation platform 260. Accordingly, as mentioned above, this may result in mutual benefit for both the users and the plurality of new item providers 265 of the online recommendation platform 260, as the former may discover new relevant digital items of interest, whereas the latter can expand their target audience.

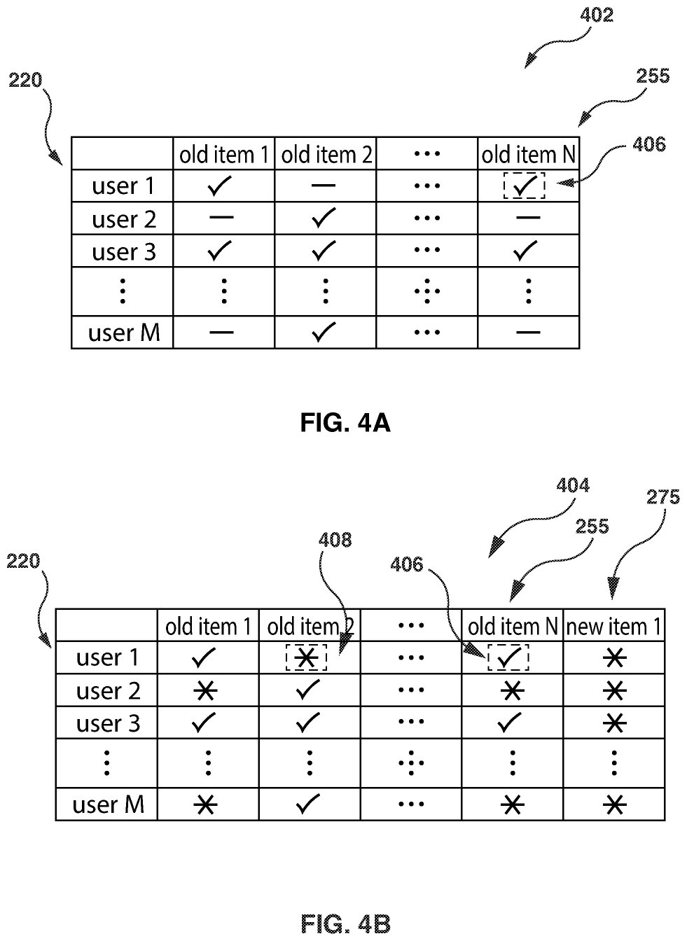

How the distribution of the indications of the user feedback over the old portion of digital items 255 can be analyzed to determine the indications of the synthetic feedback for the new digital items, in accordance with certain non-limiting embodiments of the present technology, will be described in detail below with reference to FIGS. 4 to 6.

### Scoring Machine-Learning Model

According to certain non-limiting embodiments of the present technology, to determine the respective indications of the synthetic user feedback for each new digital item of the new portion of digital items 275, as mentioned above, first, the server 250 can be configured to train, based on the respective indications of the user feedback given to some of the old portion of digital items 255, the scoring ML model to determine respective predicted indications of the user feedback for a given digital item, such as those of the old portion of digital items 255, that is devoid of any indication of the user feedback. It is not limited how the scoring ML model can be implemented. However, in some non-limiting embodiments of the present technology, the scoring ML model can be implemented as a matrix factorization ML model.

With reference to FIGS. 4A and 4B, there are depicted schematic diagrams of an input matrix 402 and an output matrix 404 of the matrix factorization ML model, in accordance with certain non-limiting embodiments of the present technology.

As it can be appreciated, the input matrix 402 has a dimension of m*n, where m is indicative of a number of the users of the online recommendation platform 260, and n is indicative of a number of old digital items in the old portion of digital items 255. Thus, a given element of the input matrix 402 includes: (i) a respective actual indication 406 of the user feedback (such as LIKE/DISLIKE, as mentioned above) given by a given user, such as the user 220, to a respective old digital item of the old portion of digital items 255; (ii) item features of the respective old digital; and (iii) user features of the user 220 that has left the respective actual indication 406 under the respective old digital item.

Broadly speaking, the matrix factorization model is an embedding ML model that can be trained, for example, by the server 250, to determine a user embedding matrix P (for example, the users of the online recommendation platform 260) and an item embedding matrix Q (for example, that of the old portion of digital items 255) such that the output matrix 404 defined as PQT approximates, at a desired confidence level, the input matrix 402. More specifically, a given row of the item embedding matrix Q includes latent item features of a given one of the old portion of digital items 255, representative of actual item features thereof; whereas a given row of the user embedding matrix P includes latent user features of the given user, such as the user 220, that are indicative of an extent of interest of the user 220 in the given one of the old portion of digital items 255, having such actual item features.

To that end, the server 250 can be configured to (i) construct an objective function (also known in the art as a “loss function”) indicative of a difference between corresponding elements of the input and output matrices 402, 404; and (ii) by minimizing the objective function, determine the elements of each one of the user and item embedding matrices P, Q. For example, in some non-limiting embodiments of the present technology, the objective function can be determined as a Root-Mean-Square Error objective function, which can be expressed by a following equation:

$${e}_{ij}^{2} = {( {r}_{ij} - {\hat{r}}_{ij} )}^{2} = {( {r}_{ij} - {\sum }_{k = 1}^{K} {p}_{ik} {q}_{kj} )}^{2} , \qquad ( 1 )$$

where rᵢⱼ is a given element of the input matrix 402;
\hat{r}ᵢⱼ is a respective element of the output matrix 404;
pᵢⱼ is a respective element of the user embedding matrix P; and
qᵢⱼ is a respective element of the item embedding matrix Q.

Thus, by minimizing the objective function, such as by using a gradient descent method, for example, the server 250 can be configured to determine the elements of the user embedding matrix P and the item embedding matrix Q. Further, based on the so determined user embedding and item embedding matrices P, Q, the server 250 can be configured to determine the elements of the output matrix 404, schematically depicted in FIG. 4B. As it can be appreciated from the output matrix 404, based on similarity between corresponding item and user features associated with those of the old portion of digital items 255 having the respective actual indications of the user feedback, the so trained matrix factorization ML model can be configured to: (i) determine, for a given one of the old portion of digital items 255 that was previously devoid of any indication of the user feedback, a respective predicted indication of the user feedback 408; and (ii) approximate pre-existing respective actual indications of the user feedback for those of the old portion of digital items 255 that had them, such as the respective old digital item associated with the respective actual indication 406 of the user feedback.

Further, in some non-limiting embodiments of the present technology, to determine the respective indications of the synthetic user feedback for each one of the new portion of digital items 275, the server 250 can be configured to (i) increase the dimension of the input matrix 402 by adding thereto columns indicative of respective ones of the new portion of digital items 275; (ii) re-determine the user embedding and item embedding matrices P, Q; and (iii) generate an updated version of the output matrix 404, which would thus include the respective indications of the synthetic user feedback being respective predicted indications of the user feedback for each one of the new portion of digital items 275.

It should be expressly understood that, aside from the matrix factorization model described above, other ML architectures can be used for implementing the scoring ML model, including, without limitation a decision tree-based ML model, a neural network-based ML model, and others.

However, as noted hereinabove, determining associations between the user features and the item features of each one of the new portion of digital items 275 through re-training the scoring ML model can be a resource-intensive task for the server 250. Also, the item features of some ones of the new portion of digital items 275 can be unavailable.

To that end, in some non-limiting embodiments of the present technology, using the predictions of the scoring ML model, the server 250 can be configured to train a synthetic user feedback generation algorithm configured to generate the respective indications of the synthetic user feedback for each one of the new portion of digital items 275 based on sparse input data, such as without considering item features of the new portion of digital items 275. More specifically, according to certain non-limiting embodiments of the present technology, the synthetic user feedback generation algorithm can be configured to determine the respective indications of the synthetic user feedback for each one of the new portion of digital items 275 such that they are distributed over the new portion of digital items 275 in accordance with a feedback distribution of the respective predicted indications of the feedback over the old portion of digital items 255. In other words, the server 250 can be configured to train the synthetic user feedback generation algorithm using the feedback distribution of the respective predicted indications of the feedback over the old portion of digital items 255 as a ground truth.

Broadly speaking, the feedback distribution is representative of how numbers of the respective predicted indications of positive and negative user feedback are distributed over the old portion of digital items 255. However, it should be expressly understood that in other non-limiting embodiments of the present technology, the feedback distribution can consider only the respective actual indications of the user feedback, provided to some ones of the old portions of digital items 255 by the users of the online recommendation platform 260.

Thus, in some non-limiting embodiments of the present technology, the server 250 can be configured to determine the feedback distribution by determining certain parameters thereof such as, without limitation, at least one of a mean average, a standard deviation, a skewness, and a kurtosis of the feedback distribution. In other non-limiting embodiments of the present technology, the server 250 can be configured to determine the feedback distribution through a graphical representation thereof.

By doing so, the computational burden on the server 250 for determining the respective indications of the synthetic user feedback can be reduced and the new digital items can further be more efficiently introduced to the users of the online recommendation platform 260.

How the server 250 can be configured to train the synthetic feedback generation algorithm considering the feedback distribution, in accordance with certain non-limiting embodiments of the present technology, will now be described.

Synthetic User Feedback Generation Algorithm. Training Phase

According to certain non-limiting embodiments of the present technology, the server 250 can be configured to train the synthetic user feedback generation algorithm to determine the respective indications of the synthetic user feedback for each one of the new portion of digital items 275 based on the old portion of digital items 255.

More specifically, according to certain non-limiting embodiments of the present technology, the server 250 can be configured to train the synthetic user feedback generation algorithm so that, given a certain sampling approach of old digital items from the old portion of digital items 255, the synthetic user feedback generation algorithm is configured to: (i) determine, for a given old digital item, such as the given one of the plurality of old digital items 257 associated with the given old item provider 247, the respective probability value of the given old digital item receiving, for example, the positive user feedback; and (ii) assign, based on the respective probability value, the respective indication of the synthetic user feedback to the given old digital item such that the respective indications of the synthetic user feedback would be distributed over the plurality of old digital items 257 in accordance with the feedback distribution, as mentioned above.

For example, the server 250 can be configured to assign the respective indication of the synthetic user feedback to the given old digital item based on the respective probability value associated therewith based on certain probability thresholds. More specifically, in response to the respective probability value being greater than a predetermined upper probability threshold (such as 0.75, 0.80, or 0.9, as an example), the server 250 can be configured to assign, to the given old digital item, a respective indication of positive synthetic user feedback; and (ii) in response to the respective probability value being lower than a predetermined lower probability threshold (such as 0.1, 0.25, or 0.4, as an example), the server 250 can be configured to assign, to the given old digital item, a respective indication of negative synthetic user feedback. Additionally, in response to the respective probability value being equal to the predetermined upper probability threshold (such as 0.75, 0.80, or 0.9, as an example), the server 250 can be configured to assign, to the given old digital item, a respective indication of the given old digital item being appreciated.

As will become apparent from the description provided hereinbelow, by training the synthetic user feedback algorithm as mentioned above, the server 250 can be configured to determine certain in-use parameters thereof. Further, the server 250 can be configured to apply the synthetic user feedback generation algorithm with the so determined in-use parameters thereof to the new portion of digital items 275.

According to certain non-limiting embodiments of the present technology, as the item features of the new portion of digital items 275 can be unavailable, the server 250 can be configured to determine other features of the old portion of digital items 255 for training the synthetic user feedback generation algorithm. More specifically, certain non-limiting embodiments of the present technology are based on a premise that similarity between the given old digital item of the old portion of digital items 255 and the respective new digital item of the new portion of digital items 275 can be determined not only based on the item features but also based on a similarity between respective old and new item providers and certain features indicative of the item popularity associated with the new portion of digital items 275 that can be obtained based on data beyond the online recommendation platform 260.

Thus, in some non-limiting embodiments of the present technology, the server 250 can be configured to represent the respective probability value as including at least one of: (i) a first respective probability value, determined based on a respective similarity score of a respective old item provider, associated with the given old digital item, relative to the plurality of old item providers 245; and (ii) a second probability value, determined based on a respective value of a popularity parameter associated with the given old digital item.

How the server 250 can be configured to determine the first and second probability values considering the feedback distribution of the respective predicted indications of the user feedback over the old portion of digital items 255, in accordance with certain non-limiting embodiments of the present technology, will now be described.

With reference to FIG. 2, according to certain non-limiting embodiments of the present technology, the server 250 can be configured to determine the first probability value of the given old digital item receiving the respective indication of the positive user feedback based on a respective similarity score of the given old item provider 247, having uploaded the given old digital item to the online recommendation platform 260, relative to the plurality of old item providers 245, in accordance with a following equation:

$$artistProb = a \cdot artistScore + b , \qquad ( 2 )$$

where artistScore is the respective similarity score of the given old item provider 247 relative to the plurality of old item providers 245; and
a and b are coefficients.

According to certain non-limiting embodiments of the present technology, the coefficients a and b are ones of the in-use parameters of the synthetic user feedback generation algorithm. Thus, as will be described in greater detail below, the server 250 can be configured to determine these coefficients using the feedback distribution as a ground truth. In other words, the server 250 can be configured to determine the coefficients a and b such that the respective indications of the synthetic user feedback, determined for each one of the old portion of digital items 255, based at least on respective first probability values thereof, would be distributed over the old portion of digital items 255 in accordance with the feedback distribution of the respective predicted indications of the user feedback over the old portion of digital items 255, determined by the scoring ML model as described above.

According to certain non-limiting embodiments of the present technology, the server 250 can be configured to determine the respective similarity score for the given old item provider 247 based on respective values of a similarity parameter between each one of the plurality of old item providers 245 and the given old item provider 247. In some non-limiting embodiments of the present technology, the similarity parameter can comprise a rank of similarity between the given old item provider 247 and an other one of the plurality of old item providers 245.

According to certain non-limiting embodiments of the present technology, the similarity between the given old item provider 247 and the other one of the plurality of old item providers can be determined based on at least one item provider feature associated therewith. For example, in those embodiments where the online recommendation platform 260 is an audio streaming platform, and the given old item provider 247 is a musician, the item provider features of the given old item provider 247 can include, without limitation: (i) a genre, in which the musician works; (ii) a number of albums that the musician has released; (iii) a language, in which the musician performs; (iv) a period of popularity associated with the musician; (v) a number of streams of the musician's songs on the online recommendation platform 260; (vi) an age group of a respective target audience of the musician; (vii) a number of the users of the online recommendation platform 260 having left at least one indication of one of the positive and negative user feedback under the songs of the musician; (viii) at least one user feature of a user of the online recommendation platform 260 mentioned above, who has left at least one indication of one of the positive and negative user feedback under the songs of the musician; and others.

Further, in some non-limiting embodiments of the present technology, the server 250 can be configured to determine the similarity between the given old item provider 247 and the other one of the plurality of old item providers 245 by: (i) generating, for each one of the plurality of old item providers 245, a respective item provider feature vector; (ii) map respective feature vectors to a multidimensional vector space; and (iii) determine, multidimensional vector space, a respective distance value between the respective item provider feature vectors representative of the given old item provider 247 and the other one of the plurality of old item providers 245. Thus, returning to the example of the given old item provider being a musician, the respective item provider feature vectors of the musicians performing in the same language or in languages of a same language group would be located closer to each other in the multidimensional vector space than those of the musicians performing in a different language. In another example, the respective item provider feature vectors of the musicians whose songs have received indications of the positive user feedback from users of a given age group would be located closer to each other in the multidimensional vector space than those of the musicians whose songs have been scored by users of a different age group.

Further, based on respective distance values between the given old item provider 247 and each other one of the plurality of old item providers 245, the server 250 can be configured to rank each one of the plurality of old item providers 245 relative to the given old item provider 247, thereby determining the respective values of the similarity parameter therebetween and the given old item provider 247.

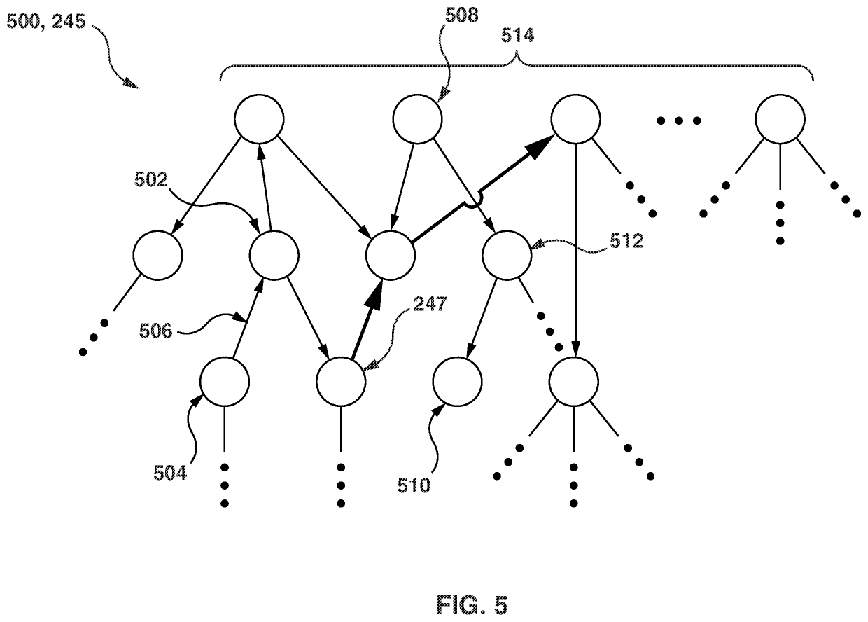

Further, to determine the respective similarity score of the given old item provider 247, according to certain non-limiting embodiments of the present technology, the server 250 can be configured, based on the respective values of the similarity parameter to generate a graph structure. With reference to FIG. 5, there is depicted a schematic diagram of an item provider similarity graph 500, in accordance with certain non-limiting embodiments of the present technology.

In some non-limiting embodiments of the present technology, the server 250 can be configured to generate the item provider similarity graph 500 such that: (i) a given vertex thereof, such as a first vertex 502, is representative of the respective old item provider of the plurality of old item providers 245; and (ii) a given edge 506, connecting the first vertex 502 and a second vertex 504, is indicative of a non-zero respective value of the similarity parameter therebetween, determined as described above. In some non-limiting embodiments of the present technology, the item provider similarity graph 500 can be a directed graph, that is, such, edges of which have an orientation indicative of relative to which respective old item provider the respective value of the similarity parameter has been determined.

Further, in some non-limiting embodiments of the present technology, the server 250 can be configured to determine, based on the respective values of the similarity parameter among the plurality of old item providers 245, respective weight values of transitions between vertices of the item provider similarity graph 500. In some non-limiting embodiments of the present technology, the server 250 can be configured to determine the respective weight value of a transition between a given pair of vertices of the item provider similarity graph 500 as being inversely proportional to the respective values of the similarity parameter between the respective old item providers disposed along this transition. For example, in cases where a given pair of vertices is connected by a respective edge, such as the first and second vertices 502, 504 connected by the given edge 506, the server 250 can be configured to determine the respective weight value of the transition from the second vertex 504 to the first vertex 502 as a value inversely proportional to the respective value of the similarity parameter between the respective old item providers respectively associated with first and second vertices 502, 504. In another example, where the given pair of vertices are not directly connected by a single edge, such as a third vertex 508 and a fourth vertex 510, however, there is a transition through a fifth vertex 512, the server 250 can be configured to determine the respective weight value of a transition from the third vertex 508 to the fourth vertex 510 as a value determined in accordance with a formula:

$$\frac{1}{R \cdot sim ( A , C ) \cdot sim ( C , B )} , \qquad ( 3 )$$

where sim(A,C) is the respective value of the similarity parameter between the third and fifth vertices 508, 512;
sim(C,B) is the respective value of the similarity parameter between the fifth and fourth vertices 512, 510; and
R is a predetermined coefficient, which can be, for example, 10.

Further, the server 250 can be configured to determine the respective similarity score associated with the given old item provider 247 as a maximum total weight value along a transition from a vertex associated with the given old item provider 247 to a vertex associated with a respective one of a set of reference old item providers 514—such as that marked bold in FIG. 5.

In some non-limiting embodiments of the present technology, each one of the set of reference old item providers 514 can be selected from the plurality of old item providers 245 randomly. In other non-limiting embodiments of the present technology, the set of reference old item providers 514 can be selected from the plurality of old item providers 245 as a given number of top popular old item providers among the users of the online recommendation platform 260. In some non-limiting embodiments of the present technology, the server 250 can be configured to identify the given number of top popular old item providers in the plurality of old item providers 245 by analyzing history of user interactions of the users of the online recommendation platform 260 with the old portion of digital items 255. For example, the server 250 can be configured to identify the given number of top popular old item providers as item providers whose old digital items have been at least one of: (i) most searched for at the online recommendation platform 260; (ii) most appreciated at the online recommendation platform 260; (iii) received the greatest number of respective indications of the positive user feedback at the online recommendation platform 260; and the like. In another example, the server 250 can be configured to (i) determine the given number of top old item providers by offering, such as via a respective GUI element in the GUI 300 of the online recommendation platform 260, the users thereof to indicate some, such as 3, 4, or 10, for example, of the plurality of old item providers 245 that are of most interest to the users; and (ii) further based, on such indications, determine the given number of top popular old item providers, comprising the set of reference old item providers 514.

Further, as mentioned hereinabove, based on the so determined respective similarity score of the given old item provider 247, the server 250 can be configured to determine the first probability value of the given old digital item of the plurality of old digital items 257 receiving the respective indication of the positive user feedback.

Further, as mentioned above, the server 250 can be configured to determine the second probability value of the given old digital item of the plurality of old digital items 257 receiving the respective indication of the positive user feedback based on the respective value of the popularity parameter associated with the given old digital item in the given area, such as a city, a county, a region, a country, and the like. In some non-limiting embodiments of the present technology, the server 250 can be configured to determine the second probability value in accordance with a following equation:

$$trackProb = c \cdot \frac{Populairty - minPopularity}{maxPopularity - minPopularity} + d , \qquad ( 4 )$$

where Popularity is the respective popularity value of the given old digital item in the given area;
maxPopularity is the respective popularity value of a most popular old digital item of the plurality of old digital items 257 of the given old item provider 247 in the given area;
minPopularity is the respective popularity value of a least popular new digital item of the plurality of old digital items 257 of the given old item provider 247 in the given area; and
c and d are coefficients.

Akin to the coefficients a and b in Equation (2), the coefficients c and d are ones of the in-use parameters of the synthetic user feedback generation algorithm. Thus, as will be described in greater detail below, the server 250 can be configured to determine these coefficients such that the respective indications of the synthetic user feedback, determined for each one of the old portion of digital items 255, based at least on respective second probability values thereof, would be distributed over the old portion of digital items 255 in accordance with the actual feedback distribution of the respective predicted indications of the user feedback over the old portion of digital items 255, determined by the scoring ML model as described above.

In the context of the present specification, the popularity parameter, as opposed to the item popularity that is determined based on the respective indications of the user feedback left on the online recommendation platform 260, as mentioned above, is a metric of popularity associated with the given old digital item determined based on indications of user interactions with the given old digital item performed outside of the online recommendation platform 260, through other sources available in the given area, such as radio stations, television channels, music clubs, live concerts, and the like, or other online resources. More specifically, returning to the example where the online recommendation platform 260 is an audio streaming platform, and the given old digital time is an audio feed, the popularity parameter can include, without limitation, at least one of: (i) a number of streams of the audio feed on a given media resource; (ii) a number of requests to play the audio feed on the given media resource; (iii) a position of the audio feed in a given record chart; (iv) a number of sold albums including the audio feed; and others.

Further, as mentioned hereinabove, based at least on one of the first and second probability values, the server 250 can be configured to determine the respective probability value of the given old digital item receiving the respective indication of the positive user feedback. In some non-limiting embodiments of the present technology, the respective probability value can be determined based only on the first probability value. In other non-limiting embodiments of the present technology, the server 250 can be configured to determine the respective probability value based only on the second probability value. In yet other non-limiting embodiments of the present technology, the server 250 can be configured to determine the respective probability value based on a combination, such as a sum, for example, of the first and second probability values.

Further, as mentioned hereinabove, the server 250 can be configured to train the synthetic user feedback generation algorithm to determine the in-use parameters thereof, such as the coefficients a, b, c, and d for further use in determining the respective indications of the synthetic user feedback for each one of the new portion of digital items 275.

To that end, according to certain non-limiting embodiments of the present technology, the server 250 can be configured to: (i) initialize the in-use parameters of the synthetic user feedback distribution algorithm, such as randomly; (ii) iteratively execute the synthetic user feedback distribution algorithm sampling different ones of the old portion of digital items 255; (iii) after a predetermined number of iterations of executing the synthetic user feedback distribution algorithm, determine a training synthetic feedback distribution of the so determined respective indications of the synthetic user feedback over the old portion of digital items 255; and (iv) adjust the in-use parameters of the synthetic user feedback generation algorithm such that the training synthetic feedback distribution corresponds, within a desired accuracy, to the feedback distribution of the respective predicted indications of the user feedback determined by the scoring ML model.

In some non-limiting embodiments of the present technology, the server 250 can be configured to use all of the old portion of digital items 255 for training the synthetic user feedback generation algorithm. However, in other non-limiting embodiments of the present technology, the server 250 can be configured to determine a training set of old digital items including a certain part of the old portion of digital items 255, such as respective pluralities of old digital items of certain ones of the plurality of old item providers 245, that the server 250 can further be configured to use for training the synthetic user feedback generation algorithm. Also, it is not limited how the server 250 can be configured to select the predetermined number of iterations of executing the synthetic user feedback generation algorithm, which can include selecting this number based on a number of digital items used for training the synthetic user feedback algorithm. In this regard, the predetermined number of iterations can include, without limitation, 100, 1000 or even tens or hundreds of thousands iterations, as an example.

It is not limited how the server 250 can be configured to sample the given old digital item from the plurality of old digital items 257, and in some non-limiting embodiments of the present technology, can comprise sampling the given old digital item based on the respective value of the popularity parameter thereof in the given area, determined as mentioned above.

For example, in some non-limiting embodiments of the present technology, the server 250 can be configured to sample the given old digital item from the plurality of old digital items 257 for determining the respective probability value thereof using one of sampling approaches, including, without limitation: (i) randomly; (ii) with a uniform sampling probability, that is, with even chances of sampling the given old digital item relative to other ones of the plurality of old digital items 257, irrespective of the respective value of the popularity parameter; (iii) with a sampling probability value proportional to the respective value of the popularity parameter, that is, with greater chances of sampling the given old digital item given a greater respective value of the popularity parameter thereof; and (iv) with a sampling probability value proportional to a square root of the respective value of the popularity parameter, that is, with greater chances of sampling the given old digital item given a greater square root value of the respective value of the popularity parameter thereof. Other sampling approaches are also envisioned.

For example, in some non-limiting embodiments of the present technology, the server 250 can be configured to adjust the in-use parameters of the synthetic user feedback generation algorithm such that differences between corresponding parameters of the training synthetic feedback distribution and the feedback distribution minimized. In another example, the server 250 can be configured to adjust the in-use parameters of the synthetic user feedback generation algorithm such that respective graphical representations of the training synthetic feedback distribution and the feedback distribution correspond to each other. It should be noted that various approaches can be used to determine the in-use parameters of the synthetic user feedback generation algorithm to meet at least one of these conditions, including, for example, optimization algorithms, further including, without limitation, those used for differentiable (such as a Gradient Descent optimization algorithm, a Newton's optimization algorithm, and others) and non-differentiable (such as a Direct optimization algorithms, Stochastic optimization algorithms, and Population optimization algorithms, and others) objective functions. Embodiments where the in-use parameters of the synthetic user generation algorithm are selected to meet at least one of the above conditions empirically are also envisioned without departing from the scope of the present technology.

Thus, by way of example only, and in no way as a limitation, the server 250 can be configured to determine the in-use parameters of the synthetic user feedback generation algorithm such that Equations (2) and (4) are represented as:

$$\{ \begin{matrix}artistProb = 0.75 \cdot artistScore + 0.05 \\ trackProb = 0.1 \cdot \frac{Populairty - minPopularity}{maxPopularity - minPopularity} - 0.05\end{matrix} . \qquad ( 5 )$$

Further, the server 250 can be configured to use the so trained synthetic user feedback generation algorithm for determining the respective indications of the synthetic user feedback for each one of the new portion of digital items 275, which will be described immediately below.

Synthetic User Feedback Generation Algorithm. In-Use Phase

According to certain non-limiting embodiments of the present technology, to use the trained synthetic user feedback generation algorithm for determining the respective indication of the synthetic user feedback for a given new digital item (devoid of any indication of the user feedback), such as the given one of the plurality of new digital items 277 associated with the given new item provider 267, the server 250 can be configured to (i) determine, for the given new digital item, at least one of the first and second in-use probability value of the given new digital item receiving the respective indication of the positive user feedback, in accordance with Equations (5); (ii) based on the at least one of the first and second in-use probability values, determine a respective in-use probability value of the given new digital item receiving the respective indication of the positive user feedback; and (iii) based on the respective in-use probability value, determine the respective indication of the one of negative and positive synthetic user feedback, as described above with respect to the training of the synthetic user feedback generation algorithm.

Akin to the above, the server 250 can be configured to determine the first in-use probability value of the given new digital item receiving the respective indication of the positive user feedback based on a respective in-use similarity score of the given new item provider 267. To that end, the server 250 can be configured to: (i) determine the respective values of the similarity parameter among the plurality of new item providers 265; and (ii) generate an in-use item provider similarity graph similarly to the item provider similarity graph 500, as described above. However, as item provider features of the plurality of new item providers 265 can also be unavailable, in some non-limiting embodiments of the present technology, the server 250 can be configured to obtain the respective values of the similarity parameter differently.

More specifically, in some non-limiting embodiments of the present technology, the server 250 can be configured to obtain, for each one of the plurality of new item providers 265, such as the given new item provider 267, the respective values of the similarity parameter relative to old item providers. To that end, in some non-limiting embodiments of the present technology, the server 250 can be configured to determine the respective values of the similarity parameter associated with the given new item provider 267 based on grades provided by human assessors.

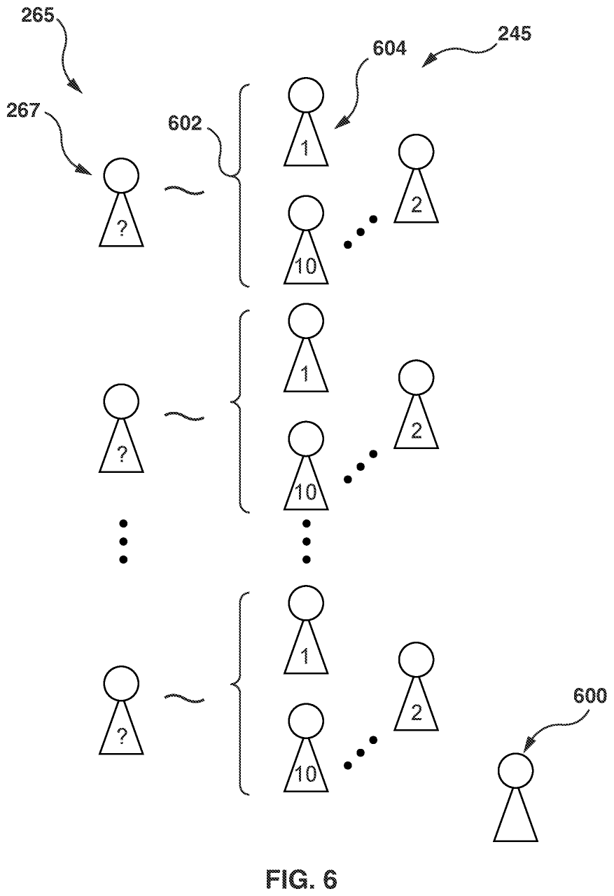

With reference to FIG. 6, there is depicted a schematic diagram of a given human assessor 600 determining respective similarity values between the plurality of new item providers 265 and respective ones of the plurality of old item providers 245, in accordance with certain non-limiting embodiments of the present technology.

Needless to say that the given human assessor 600 can access data of the plurality of old and new item providers 245, 265 via a respective electronic device, implemented similarly to the electronic device 210 of the user 220 and communicatively coupled to the server 250 via the communication network 240 as described above. Also, in some non-limiting embodiments of the present technology, the given human assessor 600 can comprise a plurality of different human assessors.

According to certain non-limiting embodiments of the present technology, the server 250 can be configured to solicit, such as by transmitting an indication of a respective grading task, the given human assessor 600 to directly provide ranks of similarity between the given new item provider 267 and, for example, a predetermined number (such as 3, 5, 10, or 20, for example) of old item providers from the plurality of old item providers 245. In response, the given human assessor 600, based on their perception of the digital items of the given new item provider 267 and the plurality of old item providers 245, can identify a respective set of similar old item providers 602. Accordingly, a given one of the respective set of similar old item providers 602 can include a respective assessor-generated label 604 indicative of the respective rank of similarity relative to the given new item provider 267. Thus, as mentioned above, the server 250 can be configured to use the so determined ranks of similarity as the respective values of the similarity parameters between each one of the plurality of new item providers 265 and respective old item providers of the plurality of old item providers 245.

Further, similar to as described above, the server 250 can be configured to generate the in-use item provider similarity graph based on (i) the plurality of new item providers 265; (ii) old item providers having non-zero respective value of the similarity parameter with a respective one of the plurality of new item providers 265—such as the respective set of similar old item providers 602 associated with the given new item provider 267; and (iii) the respective values of the similarity parameter between (i) and (ii).

Further, the server 250 can be configured to identify, in the in-use item provider similarity graph, among the plurality of new item providers 265, a set of new reference item providers, also in a similar fashion as described above with respect to the item provider similarity graph 500. Finally, as further described above, the server 250 can be configured to determine the respective similarity score of the given new item provider 267 as being a maximum total weight of a transition, along the in-use item provider similarity graph, between a vertex representative of the given new item provider 267 and a respective one of the set of reference new item providers. Accordingly, applying the Equations (5) to the so determined respective in-use similarity score, the server 250 can be configured to determine the first in-use probability value of the given new digital item receiving the positive user feedback.

Further, as described hereinabove with respect to the given old digital item, the server 250 can be configured to: (i) determine, for the given new digital item, a respective in-use value of the popularity parameter; and (ii) by applying the Equations (5) to the respective in-use value of the popularity parameter, determine the second in-use probability value of the given new digital item receiving the respective indication of the positive user feedback.

Further, as has also been mentioned above, based on at least one of the first and second in-use probability values, the server 250 can be configured to determine the respective in-use probability value of the given new digital item receiving the respective indication of the positive user feedback, based on which, the server 250 can be configured to determine the respective indication of the synthetic user feedback for the given new digital item.

Accordingly, by iteratively executing the synthetic user feedback generation algorithm for the predetermined number of iteration sampling, at each given iteration, an other new digital item from the new portion of digital items 275, as described above with respect to the old portion of digital items 255, the server 250 can be configured to generate the respective indications of the synthetic user feedback for each one of the new portion of digital items 275.

However, in other non-limiting embodiments of the present technology, the server 250 can be configured to determine the respective indications of the synthetic user feedback for each one of the new portion of digital items 275 differently. More specifically, in these embodiments, the server 250 can be configured to: (i) identify, for the given new item provider 267, a respective reference old item provider from the plurality of old item providers 245; (ii) determine, a local feedback distribution of the respective indications of the user feedback over the respective plurality of old digital items associated with the respective reference old item provider; and (iii) assign to, the plurality of new digital items 277 associated with the given new item provider 267, the respective indications of the synthetic user feedback in accordance with the local feedback distribution.

It is not limited how the server 250 can be configured to identify the respective old reference item provider for the given new item provider 267. In some non-limiting embodiments of the present technology, the server 250 can be configured to determine the respective old reference item provider as being a most similar one to the given new item provider 267 from the plurality of old item providers 245. For example, in these embodiments, the server 250 can be configured to determine the most similar one to the given new item provider 267 from the plurality of old item providers 245 based on the labels of human assessors, as described above with reference to FIG. 6. Thus, for example, the server 250 can be configured to determine the respective reference old item provider for the given new item provider 267 as being a top ranked one from the set of similar old item providers 602.

However, in other non-limiting embodiments of the present technology, the server 250 can be configured to identify the respective reference old item provider for the given new item provider 267 as a most popular one from the plurality of old item providers 245, as mentioned above with reference to FIG. 5.

Further, in some non-limiting embodiments of the present technology, the server 250 can be configured to determine the local feedback distribution only of the respective actual indications of the user feedback over the respective plurality of old digital items associated with the respective reference old item provider. In other non-limiting embodiments of the present technology, the server 250 can be configured to determine the local feedback distribution of the respective predicted indications of the user feedback over the respective plurality of old digital items, determined by the scoring ML model as described above.

Further, it is not limited how the server 250 can be configured to determine the local feedback distribution; and it can include any of the approaches described above with respect to the feedback distribution.

Thus, having determined the local distribution of the respective indications of the user feedback over the respective plurality of old digital items of the respective reference old item provider, the server 250 can be configured to assign the respective indication of the synthetic user feedback to each one of the plurality of new digital items 277 in accordance with such a distribution.

By way of example, let it be assumed that the respective plurality of old digital items of the respective reference old item provider has five old digital items with the respective indications of the positive/negative user feedback distributed thereover as [100/25; 108000/580; 9995874/36954; 135001/398; 127/24]. Thus, using this local feedback distribution, the server 250 can be configured to assign the respective indications of the synthetic user feedback to the plurality of new digital items 277 such that the corresponding differences between parameters, such as the average and the standard deviation, between the local feedback distribution and a so formed distribution of the respective indications of the synthetic user feedback over the plurality of new digital items 277, as mentioned above, are minimized. Thus, if the plurality of new digital items 277 also has five digital elements, the server 250 can be configured to determine the respective indications of the synthetic user feedback therefor which would coincide with the local feedback distribution in the above example. By doing so, the server 250 can be said to mimic the local feedback distribution of the respective indications of the user feedback given to the respective plurality of old digital items for generating the respective indications of the synthetic user feedback for each one of the plurality of new digital items 277.

Thus, having determined the respective indications of the synthetic user feedback for each one of the new portion of digital items 275, the server 250 can further be configured to use the new portion of digital items 275 to train the MLA 280 for identifying the set of recommended digital items 225 as described above. More specifically, the server 250 can be configured to generate a new training set of data including a plurality of new training digital objects, a given one of which includes at least: (i) an indication of the given new digital item of the new portion of digital items 275; and (ii) at least one indication of the synthetic user feedback determined as described above. Further, the server 250, based on the plurality of new training digital objects, can be configured to train the MLA 280 to determine the respective likelihood value of the user 220 positively engaging with the given new digital item, and based on the respective likelihood value, identify, among other ones of the old and new portions of digital items 255, 275, the set of recommended digital items.

In the non-limiting embodiments of the present technology, the MLA 280 may be based on neural networks (NN), convolutional neural networks (CNN), Transformer neural networks, decision tree models, gradient boosted decision tree-based MLA, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like. For training the MLA 280, the server 250 may have employed a supervised-learning approach without departing from the scope of the present technology.

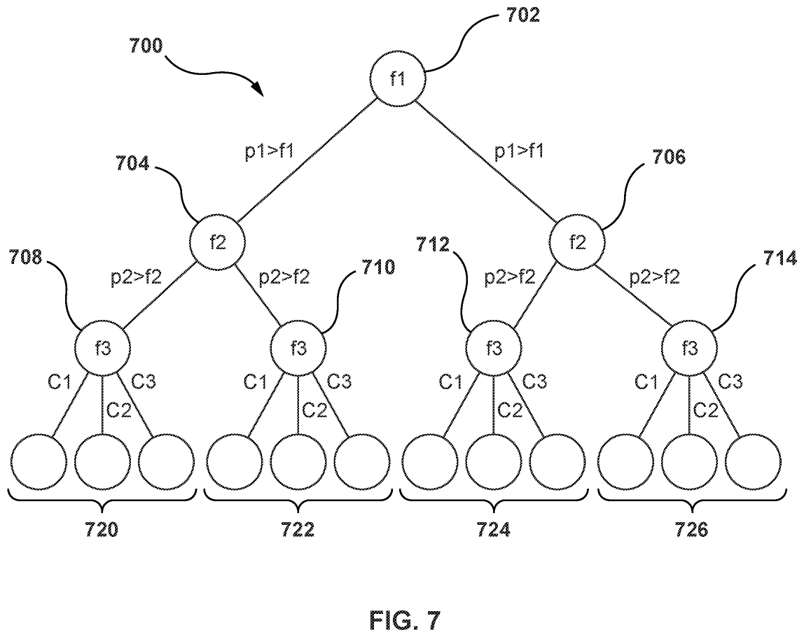

An example machine-learning model, based on which the MLA 280 can be implemented and a training process thereof, in accordance with at least some non-limiting embodiments of the present technology, will be described immediately below with reference to FIG. 7.

### Machine-Learning Model Architecture

With reference to FIG. 7, there is depicted a schematic diagram of a decision tree model 700 that can be used with at least some non-limiting embodiments of the present technology. The decision tree model 700 aims at illustrating a generic decision tree model which may be modified so as to meet the requirements of a specific prediction model, such as the MLA 280. Such modifications may include, for example, but without being limited, adding or removing one or more level of the tree, adding or removing nodes (i.e., features and the associated splits), adding or removing branches connecting the nodes and/or the leaves of the tree.

The decision tree model 700 may be a trained tree model. In some non-limiting embodiments of the present technology, the decision tree model 700 may, once generated, be updated and/or modified to improve, for example, a level of accuracy of the machine-learning model and/or a scope of application of the machine-learning model. In some embodiments, the decision tree model 700 may be relied upon to determine, for example, but without being limited to, the respective likelihood values of users of the online recommendation platform 260, such as the user 220, positively engaging with each one of the plurality of digital items 235 hosted by the online recommendation platform 260. Other fields in which the decision tree model 700 may be relied upon may also be envisioned without departing from the scope of the present technology.

The decision tree model 700 comprises a first node 702 associated with a first feature “f1”. The first node 702 defines a first level of the decision tree model 700. The first node 702 is connected through branches to a second node 704 and a third node 706. The second node 704 and the third node 706 are both associated with a second feature “f2”. The second node 704 and the third node 706 define a second level of the decision tree model 700. In some non-limiting embodiments of the present technology, the first feature “f1” and the split for the first feature “f1” have been selected amongst a set of features to be positioned at a first level of the decision tree model 700 on the basis of a plurality of training digital objects. For example, a given feature may characterize at least one of: a given digital item, a given user having interacted therewith, and a how the give user interacted with the given item, as will be described in a greater detail below.

The first feature “f1” is defined so that, for a given digital object, a value of a parameter associated with the first feature “f1” determines whether the digital object is to be associated with the second node 704 or the third node 706. As an example, if the value is less than a value “f1” then the digital object is associated with the second node 704. As another example, if the value is more than the value “f1” then the digital object is associated with the third node 706.

In turn, the second node 704 is associated with a fourth node 708 associated with a third feature “f3” and a fifth node 710 associated with the third feature “f3”. The third node 706 is associated with a sixth node 712 associated with the third feature “f3” and a seventh node 714 associated with the third feature “f3”. The fourth node 708, the fifth node 710, the sixth node 712 and the seventh node 714 define a third level of the decision tree model 700. As previously described in connection with the first node 702, for a given digital object, a value of a parameter associated with the second feature “f2” determines whether the digital object is to be associated with the fourth node 708 or the fifth node 710 (if the digital object is associated with the second node 704) or the sixth node 712 or the seventh node 714 (if the digital object is associated with the third node 706).

In turn, each one of the fourth node 708, the fifth node 710, the sixth node 712 and the seventh node 714 are associated with sets of predicted parameters. In the example illustrated in FIG. 7, the sets of predicted parameters comprise a first set 720, a second set 722, a third set 724 and a fourth set 726. Each one of the sets of predicted parameters comprises three targets, namely “C1”, “C2” and “C3”, provided, for example, by human assessors, as will become apparent from the description provided below.

As a person skilled in the art of the present technology may appreciate, the decision tree model 700 illustrates an embodiment wherein a particular level of the decision tree model 700 is associated with one feature. In the example of FIG. 7, a first level comprises the first node 702 and is associated with the first feature “f1”; a second level comprises the second node 704 and the third node 706 and is associated with the second feature “f2”; and a third level comprises the fourth node 708, the fifth node 710, the sixth node 712 and the seventh node 714 and is associated with the third feature “f3”.

In other words, in the embodiment of FIG. 7, the first level is associated with the first feature “f1”, the second level is associated with the second feature “f2” and the third level is associated with the third feature “f3”. Other embodiments may however be envisioned. In particular, an alternative embodiment wherein a generated tree model may include distinct features for a given level of the tree model. For example, a first level of such tree model may comprise a first node associated with a first feature “f1”, a second level may comprise a second node associated with a second feature “f2” and a third node associated with a third feature “f3”. As a person skilled in the art of the present technology may appreciate, other variations as to which features may be associated with a given level may be envisioned without departing from the scope of the present technology.

Further, how the features, such as the first feature “f1”, the second feature “f2”, and the third feature “f3”, have been selected for generating the decision tree model 700 is not limited. In some non-limiting embodiments of the present technology, selecting the features and thus associated splits between nodes of the decision tree model 700 can include optimizing a respective metric indicative of quality of a given feature to separate, along branches of the decision tree model 700, the plurality of training digital objects, during a training process, as each one of the plurality of training digital objects is fed to the decision tree model 700. In some non-limiting embodiments of the present technology, such a metric can include, without limitation, an Estimate of Positive Correctness metric, a Gini Impurity metric, an Information Gain metric, and the like. In specific non-limiting embodiments of the present technology, the features can be selected based on maximizing a prediction quality parameter of proto-trees making up the decision tree model 700, as described, for example, in a United States Patent Application Publication No.: 2019/164,084-A1, published on May 30, 2019, and entitled “METHOD OF AND SYSTEM FOR GENERATING PREDICTION QUALITY PARAMETER FOR A PREDICTION MODEL EXECUTED IN A MACHINE LEARNING ALGORITHM”, content of which is incorporated herein by reference in its entirety.

Further, according to certain non-limiting embodiments of the present technology, the MLA 280 may comprise a single instance of the decision tree model 700, in which case the MLA can be referred to as a single decision tree. However, in other non-limiting embodiments of the present technology, the MLA 280 can include an ensemble of decision trees implemented similarly to the decision tree model 700, in which case the MLA 280 can be referred to as a forest of decision trees. In this case, a final prediction of the ensemble of decision trees is based on prediction outcomes of each decision tree of the ensemble. How the ensemble of decision trees can be built is not limited, and may include, for example, using a boosting approach, such as a gradient boosting approach.

Generally speaking, the boosting is a method of building the ensemble of decision trees, where the trees are built in a stage-wise manner (as opposed to generating a random forest, as an example, where trees can be generated in parallel) such that a difference between targets and prediction outputs of the ensemble of decision trees is minimized, at each iteration, with generating each new decision tree thereof. The difference between the targets and the prediction outcomes of the ensemble of decision trees can be expressed, for example, by a loss function, such as a Cross-Entropy Loss Function.

It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others.

In other words, by applying the boosting approach, the MLA 280 uses decision trees as week learners, which the MLA 280 sequentially combines in a way that each new learner fits to residuals from a previous iteration, thereby improving an aggregate outcome of the whole ensemble of decision trees. Put another way, each decision tree is built on the same plurality of training digital objects, however training digital objects, in which the first decision tree made “mistakes” in predicting are prioritized when building the decision second tree, etc. Further, the MLA 280 aggregates results from each iteration forming a strong learner.

In specific non-limiting embodiments of the present technology, the MLA 280 can comprise a CatBoost ensemble of decision trees, as described, for example, in an article “(′atBoost: gradient boosting with categorical features support” by Dorogush et al., and published by YANDEX INC., content of which is incorporated herein by reference in its entirety.

Thus, generally speaking, the processor of the server 250 can be said to be executing two respective processes in respect of the MLA 280. A first process of the two processes is a training process, where the processor 110, for example, of the server 250 is configured to train the MLA 280, based on the plurality of training digital objects (also referred to herein as a “training set of data”), to determine the respective likelihood values of the user 220 positively engaging with cach one of the plurality of digital items 235.

A second process is an in-use process, where the processor of the server 250 executes the so-trained MLA 280 for determining the respective likelihood values of the user 220 positively engaging with each one of the plurality of digital items 235, in accordance with the non-limiting embodiments of the present technology. However, in some non-limiting embodiments of the present technology, the MLA can be trained at a third-party server; and the server 250 can be configured to execute the MLA 280.

It should be expressly understood that, in some non-limiting embodiments of the present technology, the MLA 280 can include more than one machine-learning model configured to determine the respective likelihood values of the user 220 positively engaging with the plurality of digital items 235. More specifically, along with the decision tree model 700 described above, the MLA 280 can further include additional machine-learning models. In various non-limiting embodiments of the present technology, a given additional machine-learning model can include, for example, a deep structured semantic machine-learning model. In various non-limiting embodiments of the present technology, the deep structured semantic machine-learning model can be trained, by the server 250, based on a same or different plurality of training digital objects, which is used for training the decision tree model 700.

Thus, having trained the MLA 280 based on the new training set of data, the server 250 can be configured to introduce at least some of the new portion of digital items 275 to the user 220 as part of the set of recommended digital items 225.

Also, after introducing the given new digital item of the new portion of digital items 275, via assigning thereto the respective indication of the synthetic user feedback, to the user 220, as mentioned above, the server 250 can be configured to receive the respective indication of the user feedback from the user 220. To that end, if the respective indication of the user feedback from the user 220 is different from the respective indication of the synthetic user feedback, the server 250 can be configured to replace the latter with the former. However, in other non-limiting embodiments of the present technology, the server 250 can be configured to add the respective indication of the user feedback from the user 220 to the so generated respective indication of the synthetic user feedback.

### First Method

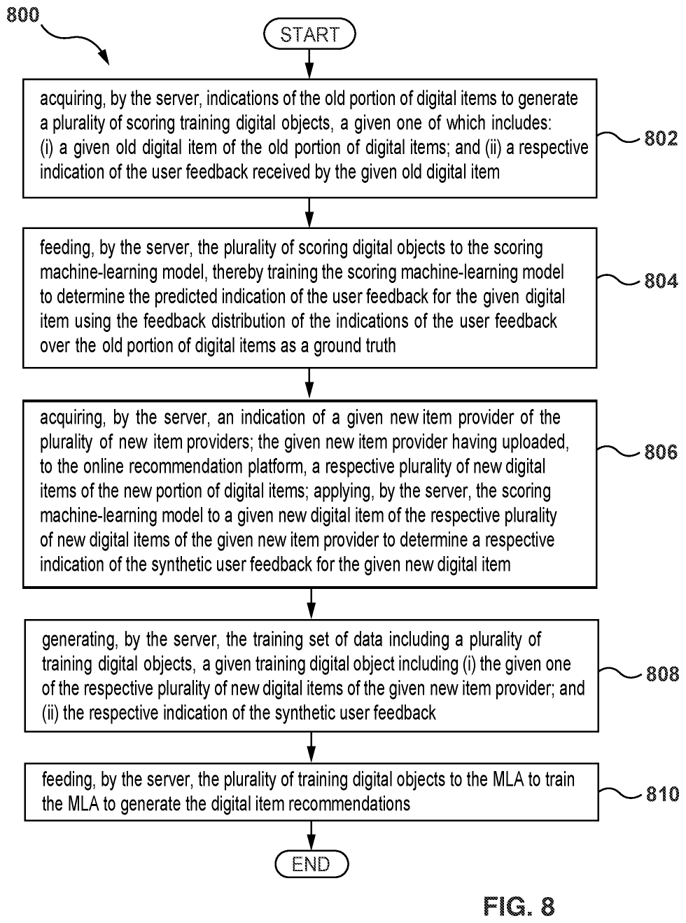

Given the architecture and the examples provided hereinabove, it is possible to execute a method for generating a training set of data for training an MLA, such as the MLA 280, to generate digital item recommendations for the users of the online recommendation platform 260. With reference now to FIG. 8, there is depicted a flowchart of a first method 800, according to certain non-limiting embodiments of the present technology. The method 800 may be executed by server 250.

As mentioned hereinabove, the server 250 can be configured to generate the training set of data for training the MLA by generating the respective indications of the synthetic user feedback for new digital items that are devoid of any indication of the user feedback of actual users of the online recommendation platform 260.

Step 802: Acquiring, by the Server, Indications of the Old Portion of Digital Items to Generate a Plurality of Scoring Training Digital Objects, a Given One of which Includes: (I) a Given Old Digital Item of the Old Portion of Digital Items; and (II) a Respective Indication of the User Feedback Received by the Given Old Digital Item

The first method 800 commences at step 802 with the server 250 being configured to train the scoring ML model to determine the respective indications of the synthetic user feedback for digital items, such as the new portion of digital items 275. To that end, as mentioned hereinabove, the server 250 can be configured to: (i) train the scoring ML model to determine the respective predicted indications of the user feedback for those of the old portion of digital items 255 that are devoid of any indication of the user feedback; (ii) determine the feedback distribution of the respective predicted indications of the user feedback over the old portion of digital items; and (iii) based on the feedback distribution, determine the in-use parameters of the synthetic feedback distribution algorithm, including the coefficients of Equations (2) and (4), for further use in determining the respective indications of the synthetic user feedback for each one of the new portion of digital items 275.

As described above with reference to FIGS. 4A and 4B, the server 250 can be configured to train the scoring ML model to determine the respective predicted indications of the user feedback, such as the respective predicted indication 408 for the user 220 for the respective other one of the old portion of digital items 225 based on the respective actual indications of the user feedback, such as the respective actual indication 406 given by the user 220 to the respective one of the old portion of digital items 255.

As mentioned herein above, in some non-limiting embodiments of the present technology, the scoring ML model comprises the matrix factorization ML model, for training which, as described with reference to FIG. 4A, the server 250 can be configured to generate the input matrix 402 including a plurality of scoring training digital objects. More specifically, the input matrix 402 has a dimension of m*n, where m is indicative of a number of the users of the online recommendation platform 260, and n is indicative of a number of old digital items in the old portion of digital items 255. Thus, a given element of the input matrix 402, representative of a respective scoring training digital object of the plurality of scoring training digital objects, includes: (i) the respective actual indication 406 of the user feedback given by the user 220 to the respective old digital item of the old portion of digital items 255; (ii) the item features of the respective old digital; and (iii) the user features of the user 220 that has left the respective actual indication 406 under the respective old digital item.

The first method 800 hence advances to step 804.

Step 804: Feeding, by the Server, the Plurality of Scoring Digital Objects to the Scoring Machine-Learning Model, Thereby Training the Scoring Machine-Learning Model to Determine the Predicted Indication of the User Feedback for the Given Digital Item Using the Feedback Distribution of the Indications of the User Feedback Over the Old Portion of Digital Items as a Ground Truth

At step 804, the server 250, based on the plurality of scoring training digital object represented by the input matrix 402, can be configured to train the scoring ML model to determine the respective indication of the synthetic user feedback for the given new digital item using the feedback distribution as a ground truth.

To that end, as described in detail with reference to FIGS. 4A and 4B, first, the server 250 can be configured to train the scoring ML model to determine the respective predicted indications of the user feedback by determining, based on the input matrix 402, the user and item embedding matrices P and Q such that the elements of the output matrix 404, defined as PQT, closely approximate the respective elements of the input matrix 402. Thus, the output matrix 404 so determined (i) for the given one of the old portion of digital items 255 that was previously devoid of any indication of the user feedback, includes the respective predicted indication of the user feedback 408; and (ii) for those of the old portion of digital items 255 that had pre-existing respective actual indications of the user feedback, such as the respective old digital item associated with the respective actual indication 406 of the user feedback, approximates such indications within the desired accuracy.

Further, according to certain non-limiting embodiments of the present technology, the server 250 can be configured to determine the feedback distribution of the respective predicted indications of the user feedback, determined by the scoring ML model, over the old portion of digital items 255. For example, as mentioned above, the server 250 can be configured to determine at least one of: (i) parameters of the feedback distribution, such as, without limitation, the mean average, the standard deviation, the skewness, and the kurtosis of the feedback distribution; and (ii) the graphical representation thereof.

Further, using the feedback distribution, the server 250 can be configured to determine the in-use parameters of the synthetic user feedback generation algorithm for application thereof to the new portion of digital items 275. More specifically, according to certain non-limiting embodiments of the present technology, the server 250 can be configured to determine the in-use parameters of the synthetic user feedback generation algorithm, such as the coefficients of the Equations (2) and (4), such that the respective indications of the synthetic user feedback determined thereby are distributed over the new portion of digital items 275 in accordance with the feedback distribution.

To that end, according to certain non-limiting embodiments of the present technology, the server 250 can be configured to train the synthetic user feedback generation algorithm based on the old portion of digital items 255. More specifically, the server 250 can be configured to train the synthetic user feedback generation algorithm so that, given a certain sampling approach of old digital items from the old portion of digital items 255, the synthetic user feedback generation algorithm is configured to: (i) determine, for the given old digital item, such as the given one of the plurality of old digital items 257 associated with the given old item provider 247, the respective probability value of the given old digital item receiving, for example, the positive user feedback; and (ii) assign, based on the respective probability value, the respective indication of the synthetic user feedback to the given old digital item such that the respective indications of the synthetic user feedback would be distributed over the plurality of old digital items 257 in accordance with the feedback distribution, as mentioned above.

For example, the server 250 can be configured to assign the respective indication of the synthetic user feedback to the given old digital item based on the respective probability value associated therewith based on predetermined upper and lower probability thresholds, as mentioned above.

According to certain non-limiting embodiments of the present technology, as has also been mentioned further above, as the item features of the new portion of digital items 275 can be unavailable, the server 250 can be configured to determine other features of the old portion of digital items 255 for training the synthetic user feedback generation algorithm. More specifically, the server 250 can be configured to determine, for the given old digital item of the old portion of digital items 255: (i) the respective similarity score of the given old item provider 247 of the given old digital item relative to other ones of the plurality of old item providers 245; and (ii) the respective value of the popularity parameter.

According to certain non-limiting embodiments of the present technology, the server 250 can be configured to determine the respective similarity score associated with the given old item provider 247 based on the item provider similarity graph 500, as described in detail with reference to FIG. 5. As described further above, the server 250 can be configured to determine the respective value of the popularity parameter associated with the given old digital item based on data from sources outside of the online recommendation platform 260.

Further, in some non-limiting embodiments of the present technology, the server 250 can be configured to determine the respective probability value of the given old digital item receiving the respective indication of the positive user feedback based on at least one of: (i) the first respective probability value, determined based on the respective similarity score associated with the given old item provider 247 in accordance with Equation (2); and (ii) the second probability value, determined based on the respective value of a popularity parameter associated with the given old digital item in accordance with Equation (4).

Further, the server 250 can be configured to determine the coefficients a, b, c, and d of Equations (2) and (4), being the in-use parameters of the synthetic user feedback generation algorithm, using the feedback distribution of the respective predicted indications of the user feedback over the old portion of digital items 255 as a ground truth. To that end, as described in detail above, according to certain non-limiting embodiments of the present technology, the server 250 can be configured to: (i) initialize the in-use parameters of the synthetic user feedback distribution algorithm, such as randomly; (ii) iteratively execute the synthetic user feedback distribution algorithm sampling different ones of the old portion of digital items 255; (iii) after the predetermined number of iterations of executing the synthetic user feedback distribution algorithm, determine the training synthetic feedback distribution of the so determined respective indications of the synthetic user feedback over the old portion of digital items 255; and (iv) adjust the in-use parameters of the synthetic user feedback generation algorithm such that the training synthetic feedback distribution corresponds, within a desired accuracy, to the feedback distribution of the respective predicted indications of the user feedback determined by the scoring ML model.

Thus, the server 250 can be configured to determine the in-use parameters of the synthetic user feedback generation algorithm such that Equations (2) and (4) are represented by Equations (5), which now can be used for determining the respective indications of the synthetic user feedback for each one of the new portion of digital items 275.

The first method 800 hence advances to step 806.

Step 806: Acquiring, by the Server, an Indication of a Given New Item Provider of the Plurality of New Item Providers; the Given New ITEM PROVIDER HAVING UPLOADED, TO THE ONLINE RECOMMENDATION Platform, a Respective Plurality of New Digital Items of the New Portion of Digital Items; Applying, by the Server, the Scoring Machine-Learning Model to a Given New Digital Item of the Respective Plurality of New Digital Items of the Given New Item Provider to Determine a Respective Indication of the Synthetic User Feedback for the Given New Digital Item

At step 806, according to certain non-limiting embodiments of the present technology, the server 250 can be configured to acquire, from the plurality of new item providers 265, the new portion of digital items 275, and apply thereto the synthetic user feedback generation algorithm with the parameters determined at step 804.

To that end, the server 250 can be configured to (i) determine, for the given new digital item, at least one of the first and second in-use probability value of the given new digital item receiving the respective indication of the positive user feedback, in accordance with Equations (5); (ii) based on the at least one of the first and second in-use probability values, determine the respective in-use probability value of the given new digital item receiving the respective indication of the positive user feedback; and (iii) based on the respective in-use probability value, determine the respective indication of the one of negative and positive synthetic user feedback, as described above with respect to the training of the synthetic user feedback generation algorithm.

Akin to the above, the server 250 can be configured to determine the first in-use probability value of the given new digital item receiving the respective indication of the positive user feedback based on the respective in-use similarity score of the given new item provider 267. In some non-limiting embodiments of the present technology, the server 250 can be configured to determine the respective in-use similarity score associated with the given new item provider 267 based on the in-use item provider similarity graph, constructed in a similar manner as the item provider similarity graph 500, however, based on respective values of similarity parameters between the plurality of old and new item providers 245, 265, obtained from human assessors, as described in detail with reference to FIG. 6. Having determined the respective in-use similarity score, using the Equations (5), the server 250 can be configured to determine the first in-use probability value of the given new digital item receiving the respective indication of the positive user feedback.

Further, the server 250 can be configured to: (i) determine, for the given new digital item, the respective in-use value of the popularity parameter; and (ii) by applying the Equations (5) to the respective in-use value of the popularity parameter, determine the second in-use probability value of the given new digital item receiving the respective indication of the positive user feedback.

Further, as has also been mentioned above, based on at least one of the first and second in-use probability values, the server 250 can be configured to determine the respective in-use probability value of the given new digital item receiving the respective indication of the positive user feedback, based on which, the server 250 can be configured to determine the respective indication of the synthetic user feedback for the given new digital item.

Accordingly, by iteratively executing the synthetic user feedback generation algorithm for the predetermined number of iteration sampling, at each given iteration, an other new digital item from the new portion of digital items 275, as described above with respect to the old portion of digital items 255, the server 250 can be configured to generate the respective indications of the synthetic user feedback for each one of the new portion of digital items 275.

The first method 800 thus proceeds to step 808.

Step 808: Generating, by the Server, the Training Set of Data Including a Plurality of Training Digital Objects, a Given Training Digital Object Including (I) the Given One of the Respective Plurality of New Digital Items of the Given New Item Provider; and (II) the Respective Indication of the Synthetic User Feedback

Thus, having determined the respective indications of the synthetic user feedback for each one of the new portion of digital items 275, at step 808, the server 250 can further be configured to use the new portion of digital items 275 with the so determined respective indications of the synthetic user feedback for generating the new training set of data including the plurality of new training digital objects, the given one of which includes at least: (i) an indication of the given new digital item of the new portion of digital items 275; and (ii) at least one indication of the synthetic user feedback determined as described above.

The first method 800 hence advances to step 810.

### Step 810 Feeding, by the Server, the Plurality of Training Digital Objects to the Mla to Train the Mla to Generate the Digital Item Recommendations

Finally, at step 810, based on the plurality of new digital items, the server 250 can be configured to train the MLA 280 for identifying the set of recommended digital items 225 as described above. More specifically, the server 250, based on the plurality of new training digital objects, can be configured to train the MLA 280 to determine the respective likelihood value of the user 220 positively engaging with the given new digital item, and based on the respective likelihood value, identify, among other ones of the old and new portions of digital items 255, 275, the set of recommended digital items, example of which is described in detail above with reference to FIG. 7.

The first method 800 thus terminates.

### Second Method

Given the architecture and the examples provided hereinabove, it is possible to execute another method for generating the training set of data for training the MLA 280 to generate digital item recommendations for the users of the online recommendation platform 260. With reference now to FIG. 8, there is depicted a flowchart of a second method 900, according to certain non-limiting embodiments of the present technology. The method 900 may also be executed by server 250.

Akin to the first method 800 described above, the second method 900 is directed to generating the training set of data for training the MLA by generating the respective indications of the synthetic user feedback for the new portion of digital items 275 that are devoid of any indication of the user feedback of actual users of the online recommendation platform 260.

Step 902: Acquiring, by the Server, an Indication of a Given New Item Provider of the New Item Providers, the Given New Item Provider Having a Plurality of New Digital Items to be Uploaded to the Online Recommendation Platform, a Given New Digital Item of the Plurality of New Digital Items being Devoid of Previous User Feedback

The second method 900 commences at step 902 with the server 250 being configured to acquire an indication of the given new item provider 267 having uploaded the plurality of new digital items 277 to the online recommendation platform 260, as described above.

The second method 900 hence advances to step 904.

Step 904: Acquiring, by the Server, an Indication of a Plurality of Old Item Providers Having Uploaded a Respective Plurality of Old Digital Items, at Least Some of the Respective Plurality of Old Digital Items Having Received User Feedback from at Least One User of the Online Recommendation Platform;

At step 904, the server 250 can be configured to acquire an indication of the plurality of old item providers 245 of the online recommendation platform 260, at least some old digital items of which have at least one actual indication of the user feedback.

The second method 900 hence advances to step 906.

Step 906: Analyzing, by the Server, the Given New Item Provider and the Plurality of Old Item Providers for Determining a Respective Reference Old Item Provider, the Determining being Executed Based on a Similarity Parameter Between the Given New Item Provider and Each of the Plurality of Old Item Providers

At step 906, the server 250 can be configured to determine, among the plurality of old item providers 245, the respective reference old item provider from the given new item provider 267. In some non-limiting embodiments of the present technology, the server 250 can be configured to determine the respective old reference item provider as being the most similar one to the given new item provider 267 from the plurality of old item providers 245. For example, in these embodiments, the server 250 can be configured to determine the most similar one to the given new item provider 267 from the plurality of old item providers 245 based on the labels of human assessors, as described above with reference to FIG. 6.

However, in other non-limiting embodiments of the present technology, the server 250 can be configured to identify the respective reference old item provider for the given new item provider 267 as a most popular one from the plurality of old item providers 245, as mentioned above with reference to FIG. 5.

The second method 900 hence advances to step 908.

Step 908: Determining, by the Server, a Feedback Distribution of Indications of the User Feedback Over the Respective Plurality of Reference Digital Items Associated with the Respective Reference Old Item Provider

At step 908, the server 250 can be configured to determine the local feedback distribution of the respective indications of the user feedback over the respective plurality of old digital items associated with the respective reference old item provider. In some non-limiting embodiments of the present technology, the server 250 can be configured to determine the local feedback distribution only of the respective actual indications of the user feedback over the respective plurality of old digital items associated with the respective reference old item provider. In other non-limiting embodiments of the present technology, the server 250 can be configured to determine the local feedback distribution of the respective predicted indications of the user feedback over the respective plurality of old digital items, determined by the scoring ML model as described above.

Further, it is not limited how the server 250 can be configured to determine the local feedback distribution; and it can include any of the approaches described above with respect to the feedback distribution.

The second method thus proceeds to step 910.

Step 910: Assigning, by the Server, Indications of the Synthetic User Feedback Over the Plurality of New Digital Items of the Given New Item Provider in Accordance with the Feedback Distribution of the Indications of the User Feedback Over the Respective Plurality of Reference Digital Items of the Respective Reference Old Item Provider;

At step 910, the server 250 can be configured to assign the respective indications of the synthetic user feedback to the plurality of new digital items 277 of the given new item provider 267 in accordance with the local feedback distribution of the respective indications of the user feedback over the respective plurality of old digital items of the respective reference old item provider.

By way of example, let it be assumed that the respective plurality of old digital items of the respective reference old item provider has five old digital items with the respective indications of the positive/negative user feedback distributed thereover as [100/25; 108000/580; 9995874/36954; 135001/398; 127/24]. Thus, using this local feedback distribution, the server 250 can be configured to assign the respective indications of the synthetic user feedback to the plurality of new digital items 277 such that the corresponding differences between parameters, such as the average and the standard deviation, between the local feedback distribution and a so formed distribution of the respective indications of the synthetic user feedback over the plurality of new digital items 277, as mentioned above, are minimized. Thus, if the plurality of new digital items 277 also has five digital elements, the server 250 can be configured to determine the respective indications of the synthetic user feedback therefor which would coincide with the local feedback distribution in the above example. By doing so, the server 250 can be said to mimic the local feedback distribution of the respective indications of the user feedback given to the respective plurality of old digital items for generating the respective indications of the synthetic user feedback for each one of the plurality of new digital items 277.

The second method 900 thus advances to steps 912 and 914 implemented similarly to steps 808 and 810, respectively, of the first method 800.

The second method 900 thus terminates.

Thus, having trained the MLA 280 based on the new training set of data generated in accordance with any one of the first and second method 800, 900, the server 250 can be configured to introduce at least some of the new portion of digital items 275 to the user 220 as part of the set of recommended digital items 225.

Also, after introducing the given new digital item of the new portion of digital items 275, via assigning thereto the respective indication of the synthetic user feedback, to the user 220, as mentioned above, the server 250 can be configured to receive the respective indication of the user feedback from the user 220. To that end, if the respective indication of the user feedback from the user 220 is different from the respective indication of the synthetic user feedback, the server 250 can be configured to replace the latter with the former. However, in other non-limiting embodiments of the present technology, the server 250 can be configured to add the respective indication of the user feedback from the user 220 to the so generated respective indication of the synthetic user feedback.

Thus, certain non-limiting embodiments of the present technology allow introducing the new digital items to the users of the online recommendation platform 260 given limited data of these new digital items, which may help improve user satisfaction of both the users and the plurality of new item providers,

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A method of generating a training set of data for training a Machine-Learning Algorithm (MLA) to generate digital item recommendations for users of an online recommendation platform, the online recommendation platform hosting a plurality of digital items, the plurality of digital items including:
(i) an old portion of digital items,
each one of the old portion of digital items having been uploaded to the online recommendation platform by a respective one of a plurality of old item providers; and
at least some old digital items of the old portion of digital items having received user feedback from at least one user of the online recommendation platform,
indications of the user feedback of the at least some old digital items being distributed over the old portion of digital items according to a feedback distribution; and
(ii) a new portion of digital items,
each one of the new portion of digital items having been uploaded to the online recommendation platform by a respective new item provider of a plurality of new item providers; and
each digital item of the new portion of digital items being devoid of any user feedback; and
the generating comprising generating synthetic user feedback for new digital items, the method being executable by a server hosting the online recommendation platform, the method comprising:
during a first stage, training, by the server, a scoring machine-learning model to determine a predicted indication of the user feedback for a given digital item, the training comprising:
acquiring, by the server, indications of the old portion of digital items to generate a plurality of scoring training digital objects, a given one of which includes: (i) a given old digital item of the old portion of digital items; and (ii) a respective indication of the user feedback received by the given old digital item; and
feeding, by the server, the plurality of scoring digital objects to the scoring machine-learning model, thereby training the scoring machine-learning model to determine the predicted indication of the user feedback for the given digital item using the feedback distribution of the indications of the user feedback over the old portion of digital items as a ground truth; and
during a second stage, following the first stage, executing:
acquiring, by the server, an indication of a given new item provider of the plurality of new item providers;
the given new item provider having uploaded, to the online recommendation platform, a respective plurality of new digital items of the new portion of digital items;
applying, by the server, the scoring machine-learning model to a given new digital item of the respective plurality of new digital items of the given new item provider to determine a respective indication of the synthetic user feedback for the given new digital item;
generating, by the server, the training set of data including a plurality of training digital objects, a given training digital object including (i) the given one of the respective plurality of new digital items of the given new item provider; and (ii) the respective indication of the synthetic user feedback; and
feeding, by the server, the plurality of training digital objects to the MLA to train the MLA to generate the digital item recommendations.

2. The method of claim 1, wherein the applying the scoring machine-learning model comprises determining a first probability value of the given new digital item of the given new digital item provider receiving an indication of positive user feedback, the determining being based on a respective similarity score of the given new item provider relative to the plurality of old item providers.

3. The method of claim 2, wherein the determining the first probability value is executed in accordance with a formula:
artistProb=a·artistScore+b,
where artistScore is the respective similarity score of the given new item provider relative to the plurality of old item providers; and
a and b are coefficients determined via the training the scoring machine-learning model.

4. The method of claim 2, further comprising determining, by the server, the respective similarity score of the given new item provider relative to the plurality of old item providers.

5. The method of claim 4, wherein the determining the respective similarity score of the given new item provider comprises:
acquiring, for a given old item provider of the plurality of old item providers, a respective value of a similarity parameter between the given old item provider and the given new item provider;
based on respective values of the similarity parameter between each one of the plurality of old item providers and the given new item provider, generating, by the server, a directed graph structure, such that:
a given vertex of the directed graph structure is representative of a respective item provider of one of the plurality of old item providers and the plurality of new item providers;
a given edge connecting a pair of vertices is representative of a non-zero respective value of the similarity parameter between the given new item provider and a respective one of the plurality of old item providers;
determining, by the server, for the given edge, a respective weight value indicative of the respective value of the similarity parameter between the given new item provider and the respective one of the plurality of old item providers; and
determining, by the server, the respective similarity score of the given new item provider as being a maximum total weight value along a transition from a respective vertex of the directed graph structure associated with the given new item provider to an initial vertex thereof.

6. The method of claim 5, wherein the determining the respective weight value comprises determining an inverse value of the respective value of the similarity parameter between the given new item provider and the respective one of the plurality of old item providers.

7. The method of claim 5, wherein the similarity parameter is a rank of similarity between the given new item provider and each one of the plurality of old item providers.

8. The method of claim 7, further comprising receiving the rank of similarity between the given new item provider and each one of the plurality of old item providers from a human assessor.

9. The method of claim 2, wherein the applying the scoring machine-learning model further comprises determining a second probability value of the given new digital item of the given new digital item provider receiving the indication of positive user feedback, the determining being based on a respective popularity value of the given new digital item in a given area.

10. The method of claim 9, wherein the determining the second probability value is executed in accordance with a formula:
$$trackProb = c \cdot \frac{Populairty - minPopularity}{maxPopularity - minPopularity} + d ,$$
where Popularity is the respective popularity value of the given new digital item in the given area;
maxPopularity is the respective popularity value of a most popular new digital item of the respective plurality of digital items of the given new item provider in the given area;
minPopularity is the respective popularity value of a least popular new digital item of the respective plurality of digital items of the given new item provider in the given area; and
c and d are coefficients determined via the training the scoring machine-learning model.

11. The method of claim 9, wherein:
the given new digital item is an audio feed; and
the respective popularity value of the given new digital item is indicative of at least one of: (i) a number of streams of the audio feed on a given media resource; (ii) a number of requests to play the audio feed on the given media resource; (iii) a position of the audio feed in a given record chart; and (iv) a number of sold albums including the audio feed.

12. The method of claim 9, further comprising:
in response to at least one of the first and second probability values being greater than a respective upper probability threshold, assigning, by the server, to the given new digital item, an indication of the positive synthetic user feedback; and
in response to the at least one of the first and second probability values being lower than a respective lower probability threshold, the respective lower probability threshold being lower than the respective upper probability threshold, assigning, by the server, to the given new digital item, an indication of negative synthetic user feedback.

13. The method of claim 12, prior to the applying the scoring machine-learning model, further comprising selecting, by the server, the given new digital item of the respective plurality of new digital items.

14. The method of claim 13, wherein the selecting comprises selecting the given new digital item from the respective plurality of new digital items one of (i) randomly; (ii) with a uniform sampling probability; (iii) with a respective sampling probability value proportional to the respective popularity value of the given new digital item in the given area; and (iv) with the respective sampling probability value proportional to the respective popularity value of the given new digital item in the given area.

15. The method of claim 13, wherein, prior to the generating the training set of data, the selecting and the applying are executed iteratively for a predetermined number of iterations.

16. The method of claim 1, wherein, in response to determining, by the server, that the given new digital item of the respective plurality of new digital items has received the user feedback, the method further comprises:
updating, by the server, the given training digital object of the plurality of training digital objects by replacing therein the respective indication of the synthetic user feedback with a respective indication of the user feedback.

17. The method of claim 1, wherein the scoring machine-learning model is a matrix factorization machine-learning model.

18. The method of claim 1, wherein the MLA is one of a decision tree-based MLA, Transformer-based MLA, and a Deep Semantic Similarity MLA.

19. A method of generating a training set of data for training a Machine-Learning Algorithm (MLA) to generate digital item recommendations for users of an online recommendation platform, the online recommendation platform hosting a plurality of digital items, the generating comprising generating synthetic user feedback for new digital items, the method being executable by a server hosting the online recommendation platform, the method comprising:
acquiring, by the server, an indication of a given new item provider of the new item providers,
the given new item provider having a plurality of new digital items to be uploaded to the online recommendation platform,
a given new digital item of the plurality of new digital items being devoid of previous user feedback;
acquiring, by the server, an indication of a plurality of old item providers having uploaded a respective plurality of old digital items, at least some of the respective plurality of old digital items having received user feedback from at least one user of the online recommendation platform;
analyzing, by the server, the given new item provider and the plurality of old item providers for determining a respective reference old item provider, the determining being executed based on a similarity parameter between the given new item provider and each of the plurality of old item providers;
based on the user feedback received by the respective plurality of old digital items of the respective reference old item provider, determining, by the server, the synthetic user feedback for the plurality of new digital items of the given new item provider, the determining including:
determining, by the server, a feedback distribution of indications of the user feedback over the respective plurality of reference digital items associated with the respective reference old item provider; and
assigning, by the server, indications of the synthetic user feedback over the plurality of new digital items of the given new item provider in accordance with the feedback distribution of the indications of the user feedback over the respective plurality of reference digital items of the respective reference old item provider;
generating, by the server, the training set of data including a plurality of training digital objects, a given training digital object including (i) the given one of the plurality of new digital items of the given new item provider; and (ii) a respective indication of the synthetic user feedback; and
feeding, by the server, the plurality of training digital objects to the MLA to train the MLA to generate the digital item recommendations.

20. A server for generating a training set of data for training a Machine-Learning Algorithm (MLA) to generate digital item recommendations for users of an online recommendation platform hosted by the server, the online recommendation platform hosting a plurality of digital items, the plurality of digital items including:
(i) an old portion of digital items,
each one of the old portion of digital items having been uploaded to the online recommendation platform by a respective one of a plurality of old item providers; and
at least some old digital items of the old portion of digital items having received user feedback from at least one user of the online recommendation platform,
indications of the user feedback of the at least some old digital items being distributed over the old portion of digital items according to a feedback distribution; and
(ii) a new portion of digital items,
each one of the new portion of digital items having been uploaded to the online recommendation platform by a respective new item provider of a plurality of new item providers; and
each digital item of the new portion of digital items being devoid of any user feedback; and
the generating comprising generating synthetic user feedback for new digital items, the server comprising a processor and a non-transitory computer-readable memory storing instructions, and the processor, upon executing the instructions, being configured to:
during a first stage, train a scoring machine-learning model to determine a predicted indication of the user feedback for a given digital item, by executing:
acquiring indications of the old portion of digital items to generate a plurality of scoring training digital objects, a given one of which includes: (i) a given old digital item of the old portion of digital items; and (ii) a respective indication of the user feedback received by the given old digital item; and
feeding the plurality of scoring digital objects to the scoring machine-learning model, thereby training the scoring machine-learning model to determine the predicted indication of the user feedback for the given digital item using the feedback distribution of the indications of the user feedback over the old portion of digital items as a ground truth; and
during a second stage, following the first stage, execute:
acquiring an indication of a given new item provider of the plurality of new item providers;
the given new item provider having uploaded, to the online recommendation platform, a respective plurality of new digital items of the new portion of digital items;
apply the scoring machine-learning model to a given new digital item of the respective plurality of new digital items of the given new item provider to determine a respective indication of the synthetic user feedback for the given new digital item;
generate the training set of data including a plurality of training digital objects, a given training digital object including (i) the given one of the respective plurality of new digital items of the given new item provider; and (ii) the respective indication of the synthetic user feedback; and
feed the plurality of training digital objects to the MLA to train the MLA to generate the digital item recommendations.
